(19) United States
(12) Patent Application Publication
(10) Pub. No.: US 2014/0081600 A1
(43) Pub. Date: Mar. 20, 2014

(54) COMPUTER-READABLE RECORDING MEDIUM HAVING STORED THEREIN DESIGN SUPPORT PROGRAM, DESIGN SUPPORTING APPARATUS, AND DESIGN SUPPORTING METHOD

(71) Applicant: FUJITSU LIMITED, Kawasaki-shi (JP)

(72) Inventor: Yoshitomo KUMAGAI, Yokohama (JP)

(73) Assignee: FUJITSU LIMITED, Kawasaki-shi (JP)

(21) Appl. No.: 13/914,672

(22) Filed: Jun. 11, 2013

(30) Foreign Application Priority Data
Sep. 20, 2012 (JP) 2012-206964

(51) Int. Cl. G06F 17/50

(52) U.S. Cl. CPC G06F 17/509
USPC 703/1

(57) ABSTRACT

A computer that prepares a network schematic diagram indicating a connection relationship of nodes in a subordinate of a designated node among a plurality of nodes, based on circuit diagram information related to the plurality of nodes constituting a network displays two or more nodes, in which connection destination nodes are the same as each other while types are the same as each other, among the plurality of nodes as one representative node or displays two or more nodes to overlap with each other, on the network schematic diagram. As a result, viewability of the network schematic diagram is improved.

### CROSS-REFERENCE TO RELATED APPLICATION

This application is based upon and claims the benefit of priority of the prior Japanese Application No. 2012-206964 filed on Sep. 20, 2012 in Japan, the entire contents of which are hereby incorporated by reference.

### FIELD

The invention relates to a computer-readable recording medium having stored therein a design support program, a design supporting apparatus, and a design supporting method.

### BACKGROUND

When an information infrastructure such as a data center is designed, a network schematic diagram illustrated in FIG. 33 is prepared from an infrastructure computer aided design (CAD) diagram illustrated in FIG. 32. On the network schematic diagram, a product designated by an operator is placed on the top thereof and the product including all transfer facilities which may communicate with the product is displayed.

That is, the network schematic diagram illustrates a connection relationship of nodes in a subordinate of a designated node among a plurality of nodes, based on circuit diagram information (infrastructure CAD information, see, for example, FIG. 32) associated with the plurality of nodes constituting a network. Further, for example, as illustrated in FIG. 33, on the network schematic diagram, the connection relationship of the nodes is displayed in the tree form by node symbols corresponding to the plurality of nodes, respectively and connection lines for coupling the node symbols including the connection relationship.

The network schematic diagram is prepared by procedures (1) to (6) described below.

(1) A processing unit such as central processing unit (CPU) acquires the number of hops by tracing a connection relationship from the product (designated node) designated by the operator. Herein, the number of hops is the number of transfer facilities (relay nodes) via until reaching from the designated node to a node of a communication counterpart, in a communication network, as illustrated in FIG. 34.

(2) The processing unit places the designated node at the center of an uppermost stage on the network schematic diagram (see FIGS. 33 and 34).

(3) The processing unit arrays nodes (machines) which belong to the subsequent number of hops at a subsequent stage so that the number of connection lines that cross each other is minimized.

(4) The processing unit divides the nodes into upper and lower parts depending on an interface (IF) attribute even in the case of nodes (machines) which belong to the same number of hops (see, for example, nodes which belong to the number of hops 2 or the number of hops 4 in FIG. 34).

(5) The processing unit arrays nodes of the subsequent stage to be nearer to the center at the time of arraying the nodes.

(6) The processing unit repeats procedures (3) to (5) until the nodes of the subsequent stage disappear.

However, in the case where the network schematic diagram is prepared in accordance with the procedures, when a system configuration has a large-scale and becomes complicated, the connection lines among the nodes complicatedly cross each other for example, as illustrated in FIG. 35, and thus, it is difficult to appreciate the network schematic diagram, and as a result, it is difficult to know the connection relationship of the nodes.

### SUMMARY

A design support program causes a computer that prepares a network schematic diagram indicating a connection relationship of nodes in a subordinate of a designated node among a plurality of nodes, based on circuit diagram information related to the plurality of nodes constituting a network, to execute a process including displaying two or more nodes, in which connection destination nodes are the same as each other while types are the same as each other, among the plurality of nodes as one representative node or displaying two or more nodes to overlap with each other, on the network schematic diagram.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 is a block diagram illustrating a hardware configuration and a functional configuration of a design supporting apparatus according to an embodiment;

FIG. 2 is a diagram describing names in a circuit diagram;

FIG. 3 is a diagram describing names, the number of stages, and the number of hops (the number of connection stages) on a network schematic diagram;

FIG. 4 is a diagram illustrating a data structure of a network schematic diagram management table;

FIG. 5 is a diagram illustrating a data structure of a product management table;

FIG. 6 is a diagram describing a relative coordinate on the network schematic diagram;

FIG. 7 is a diagram describing a display coordinate on the network schematic diagram;

FIGS. 8 to 14 are diagrams specifically describing basic preparation display processing of the network schematic diagram, by the design supporting apparatus illustrated in FIG. 1;

FIG. 15 is a flowchart describing a preparation display procedure (overall flow) of the network schematic diagram by the design supporting apparatus illustrated in FIG. 1;

FIG. 16 is a flowchart describing trace processing from a designated product (designated node) illustrated in FIG. 15 in detail;

FIG. 17 is a diagram describing the trace processing from the designated product (designated node) illustrated in FIG. 16 in detail;

FIG. 18 is a flowchart describing processing of tracing a product (node) from an IF illustrated in FIG. 16;

FIG. 19 is a diagram describing the processing of tracing the product (node) from the IF illustrated in FIG. 18;

FIG. 20 is a flowchart describing creation processing of a group link (parent-child relationship) illustrated in FIG. 15 in detail;

FIG. 21 is a diagram describing the creation processing of the group link (parent-child relationship) illustrated in FIG. 20;

FIG. 22 is a diagram describing concepts of a product (node) and a machine;

FIG. 23 is a flowchart describing first placement processing of the product (node) illustrated in FIG. 15 in detail;

FIG. 24 is a flowchart describing second placement processing of the product (node) illustrated in FIG. 15 in detail;

FIG. 25 is a flowchart describing horizontal placement processing of the product (node) illustrated in FIG. 23 in detail;

FIG. 26 is a flowchart describing third placement processing of the product (node) illustrated in FIG. 23 in detail;

FIG. 27 is a flowchart describing sorting processing of the product (node) illustrated in FIG. 25 in detail;

FIG. 28 is a flowchart describing placement processing of an isolated node illustrated in FIG. 24 (reset placement processing of a uniform product);

FIG. 29 is a diagram describing the placement processing of the isolated node illustrated in FIG. 28 (reset placement processing of the uniform product);

FIG. 30 is a flowchart describing mapping processing illustrated in FIG. 15 in detail;

FIG. 31 is a flowchart describing setting processing of a placement coordinate of a child illustrated in FIG. 30 in detail;

FIG. 32 is a diagram illustrating an example of an infrastructure CAD diagram (circuit diagram information);

FIG. 33 is a diagram illustrating an example of the network schematic diagram;

FIG. 34 is a diagram illustrating an example of the number of hops on the network schematic diagram; and

FIG. 35 is a diagram illustrating an example of a network schematic diagram prepared with respect to a large-scale and complicated system configuration.

### DESCRIPTION OF THE PREFERRED EMBODIMENTS

Hereinafter, embodiments will be described with reference to the drawings.

[1] Configuration and Function of Design Supporting Apparatus

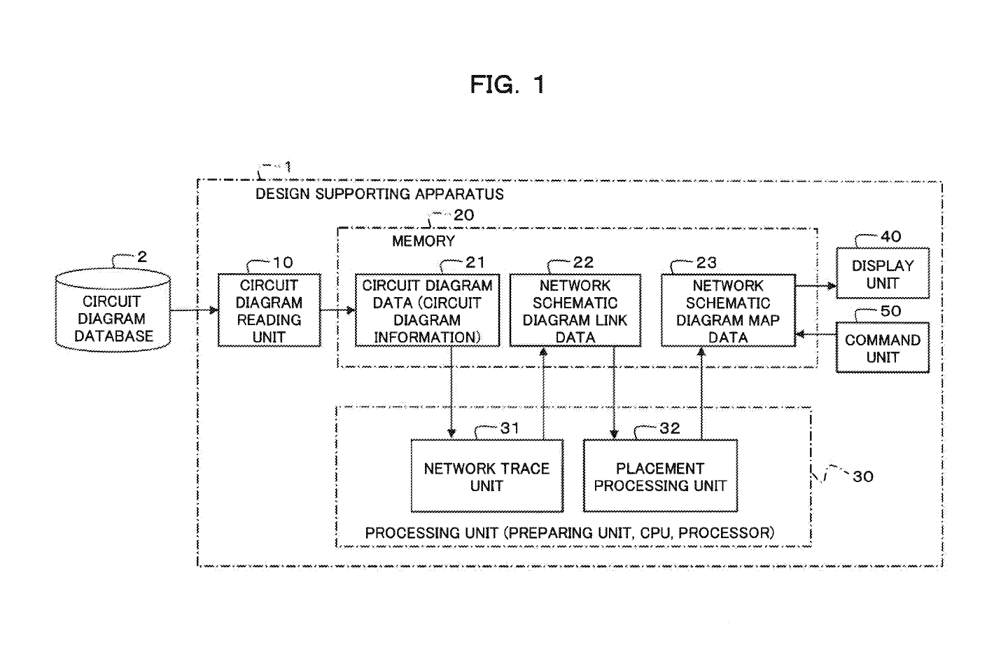

FIG. 1 is a block diagram illustrating a hardware configuration and a functional configuration of a design supporting apparatus 1 according to an embodiment. The design supporting apparatus 1 illustrated in FIG. 1 includes a circuit diagram reading unit 10, a memory 20, a processing unit 30, a display unit 40, and a command unit 50.

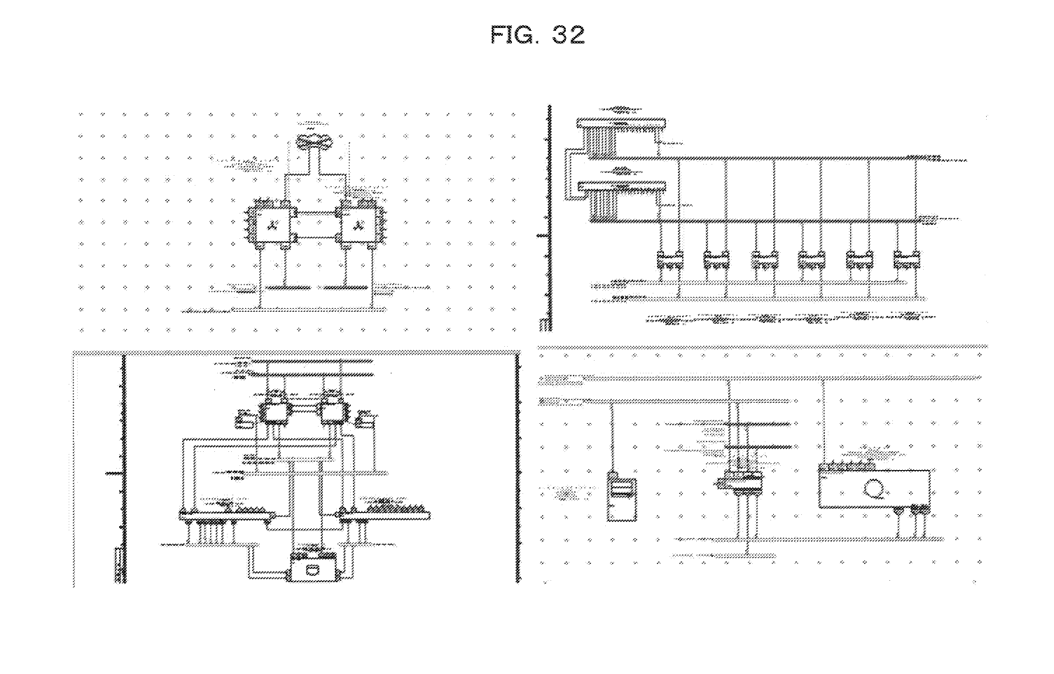

A circuit diagram database 2, which stores, in advance, circuit diagram information (infrastructure CAD information; see, for example, FIG. 32) associated with a plurality of nodes (products) constituting a network, is connected to the design supporting apparatus 1. The circuit diagram database 2 includes, for example, an external storage device attached to an exterior of the design supporting apparatus 1 or various recording media inserted into a slot provided in the design supporting apparatus 1.

The circuit diagram reading unit 10 reads infrastructure CAD information from the circuit diagram database 2 connected to the design supporting apparatus 1 to store and keep the read infrastructure CAD information in the memory (storage unit) 20 as circuit diagram data (circuit diagram information) 21.

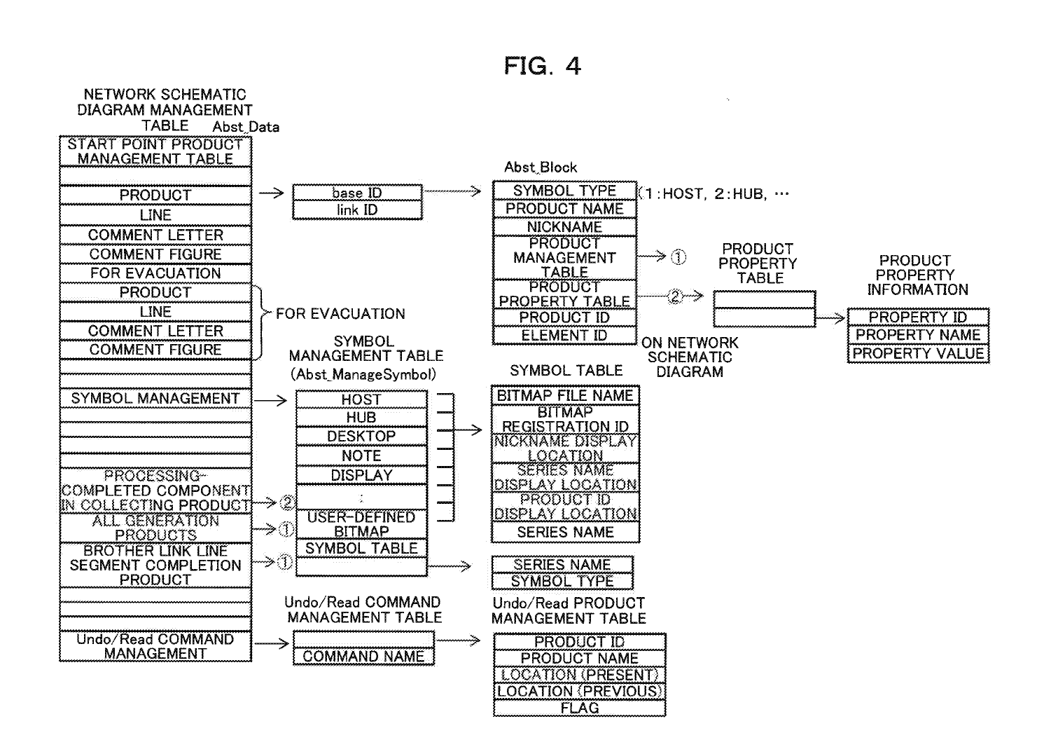

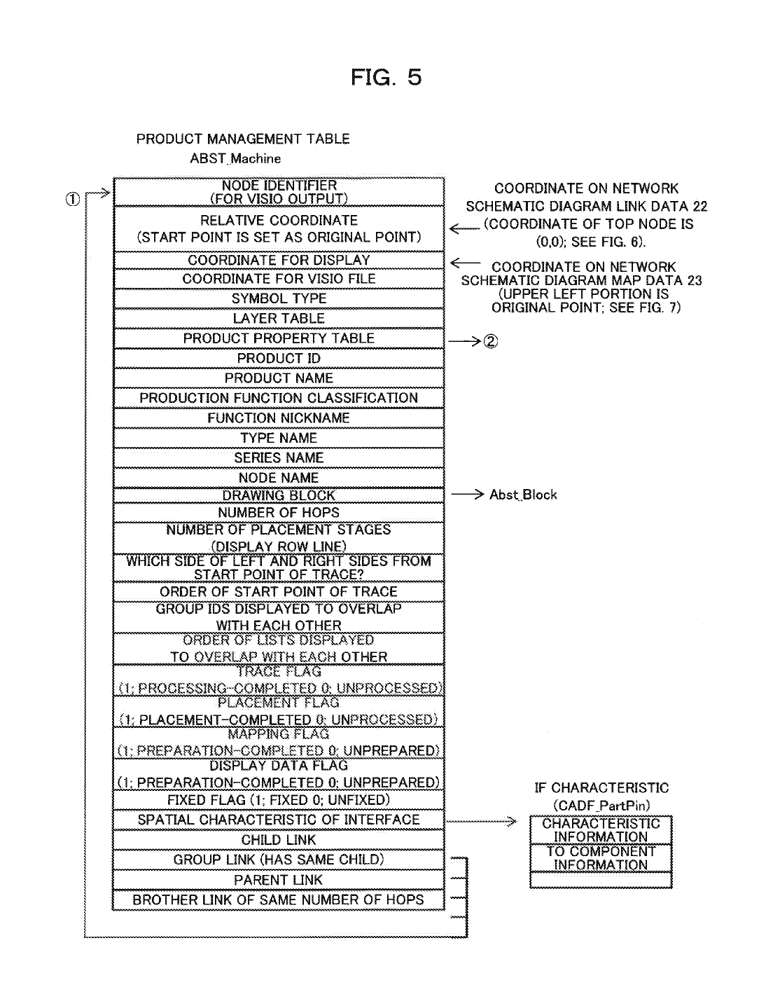

The memory 20 may be an internal storage device such as a random access memory (RAM), a hard disk drive (HDD), a solid state disk (SSD) and may be an external storage device. The memory 20 at least keeps circuit diagram data 21 read from the circuit diagram database 2 as described above, network schematic diagram link data 22 to be described below, and network schematic diagram map data 23 to be described below. Further, the memory 20 stores a design support program which causes the processing unit 30 to operate as the design supporting apparatus 1 (preparation unit) in addition to keeping a network schematic diagram management table and a product management table illustrated in FIGS. 4 and 5, respectively.

The processing unit 30 is a CPU, a processor, a computer, or the like and executes the design support program to serve as the preparation unit including a network trace unit 31 and a placement processing unit 32. The function as the preparation unit by the processing unit 30 is to prepare a network schematic diagram illustrating a connection relationship of nodes in the subordinate of a designated node (a product designated by an operator) among a plurality of nodes and display the prepared network schematic diagram on the display unit 40, based on the circuit diagram data 21 stored in the memory 20.

Herein, the network trace unit 31 traces the connection relationship from the product (designated node) designated by the operator to generate the network schematic diagram link data 22 and store the generated network schematic diagram link data 22 in the memory 20, based on the circuit diagram data 21 stored in the memory 20.

Further, the placement processing unit 32 determines a display position of each node on the network schematic diagram, that is, a placement position of each node on the network schematic diagram, and prepares the network schematic diagram, based on the network schematic diagram link data 22 stored in the memory 20. A preparation result of the network schematic diagram is stored in the memory 20 as the network schematic diagram map data 23.

In this case, the processing unit 30 (placement processing unit 32) at least has functions (a1) to (a6) described below.

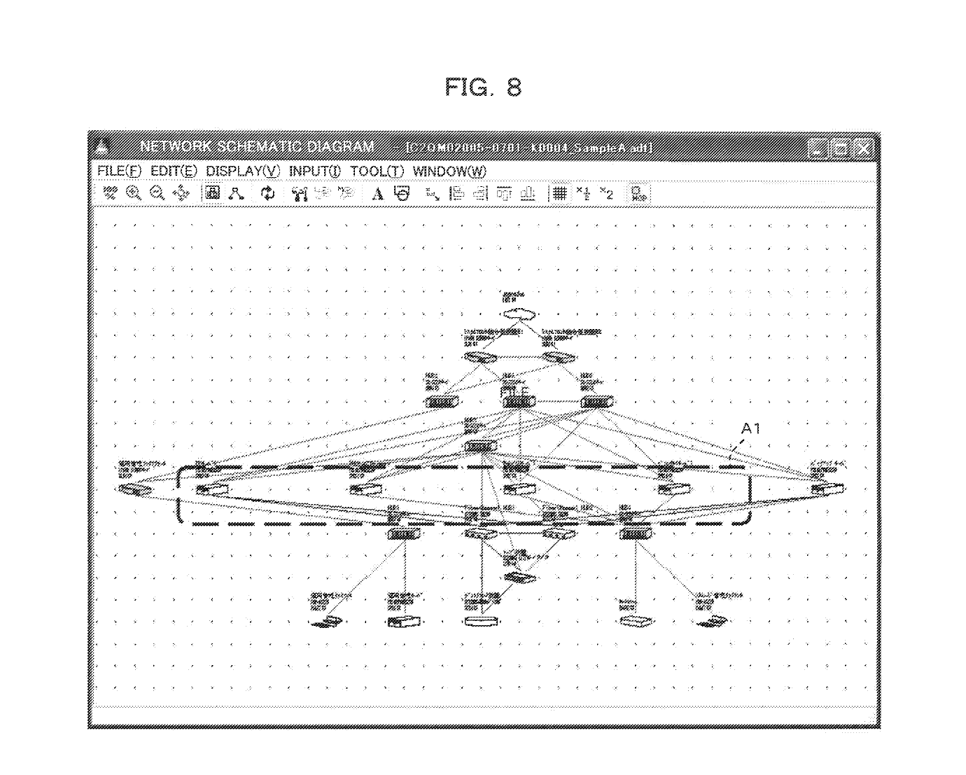

(a1) A function to display two or more nodes in which types are the same as each other and connection destination nodes are the same as each other, among a plurality of nodes, as one representative node or display two or more nodes which overlap with each other (alternatively, slightly deviate from each other), on the network schematic diagram (to be described below while referring to FIG. 8).

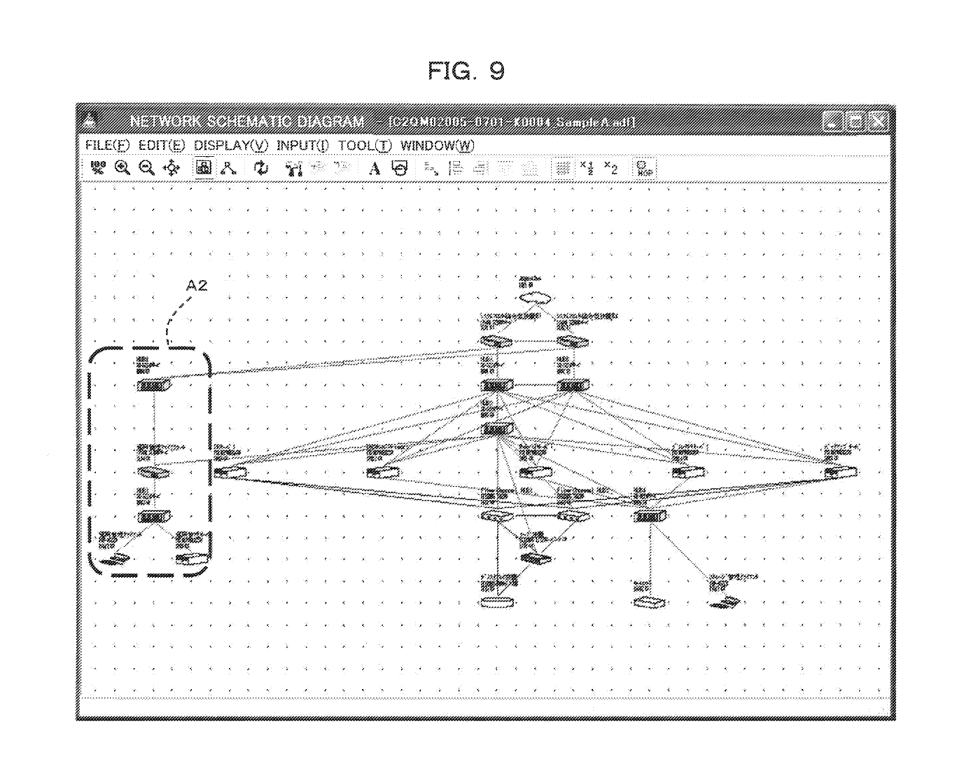

(a2) A function to place and display, on the network schematic diagram, with respect to an isolated node (uniform product) to which one lower node is connected, among the plurality of nodes, the lower node just below the isolated node. Further, a function to place and display, on the network schematic diagram, a designated node at the center of an uppermost stage and place and display a node array including the isolated node and the lower node at a position spaced apart from the central position where the designated node is placed (to be described below while referring to FIG. 9).

(a3) A function to display the connection relationship of the nodes in a tree form considering the number of connection stages (the number of hops) from the designated node by node symbols corresponding to the plurality of nodes, respectively and connection lines for coupling node symbols including the connection relationship to each other, on the network schematic diagram (see FIGS. 8 to 14).

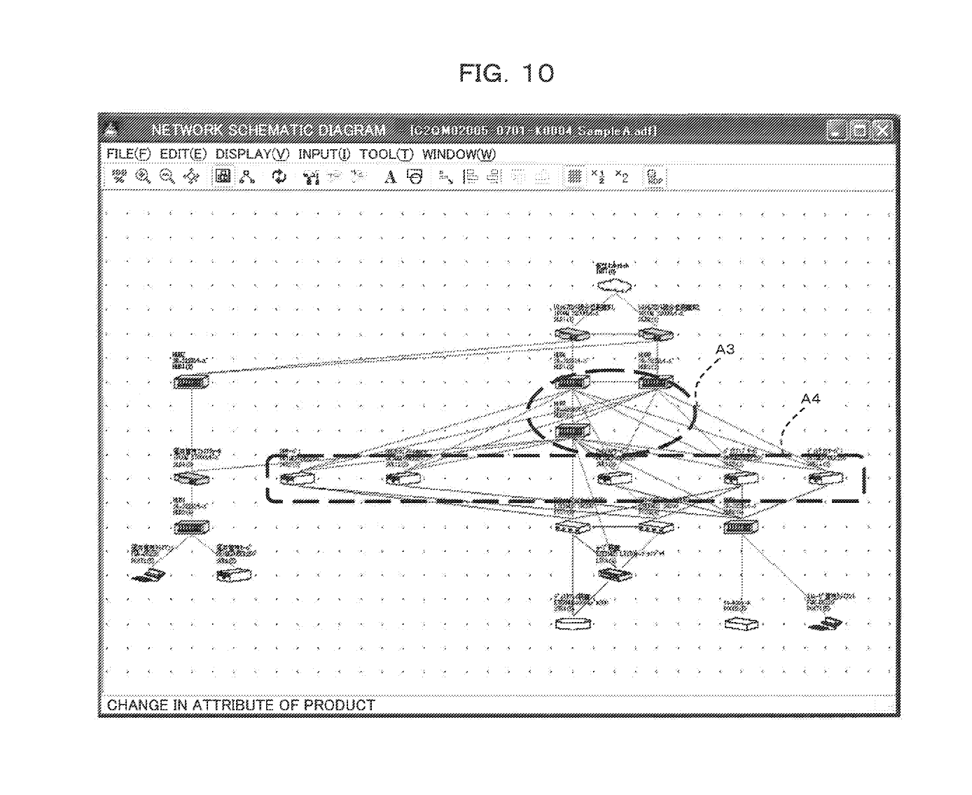

(a4) A function to place and display nodes in the same number of connection stages (the same number of hops) so that the number of connection lines that cross each other is minimized, on the network schematic diagram (see FIGS. 10 to 13).

(a5) A function to place and display nodes in the subsequent number of stages so that the number of connection lines that cross each other is minimized in the case where the number of connection lines that cross each other is not changed even though the nodes in the same number of connection stages are sorted, on the network schematic diagram (see FIGS. 10 to 13).

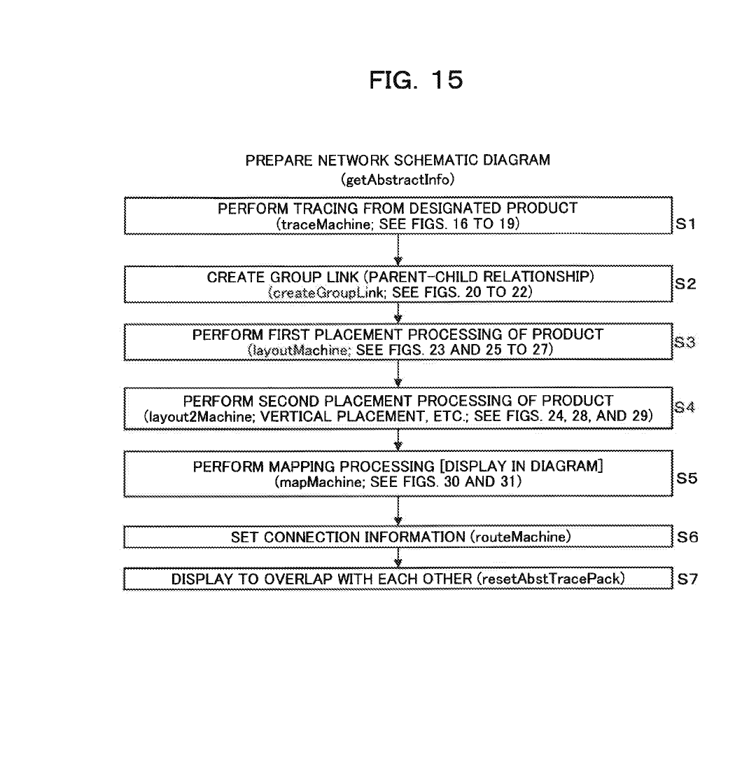

Basic preparation display processing of the network schematic diagram by the processing unit (preparation unit) 30 will be described below while referring to FIGS. 8 to 14. Further, a preparation display procedure of the network schematic diagram by the processing unit (preparation unit) 30 will be described below in detail while referring to FIGS. 15 to 31.

For example, a display status is controlled by the processing unit 30, and as a result, the display unit 40 displays the network schematic diagram based on the network schematic diagram map data 23 stored in the memory 20.

The command unit 50 performs edition processing of the network schematic diagram map data 23 in the memory 20 in accordance with a command which an operator, or the like inputs by operating a keyboard, a mouse, or the like. For example, the command unit 50 may implement the above-described function (a1) in accordance with the command input by the operator.

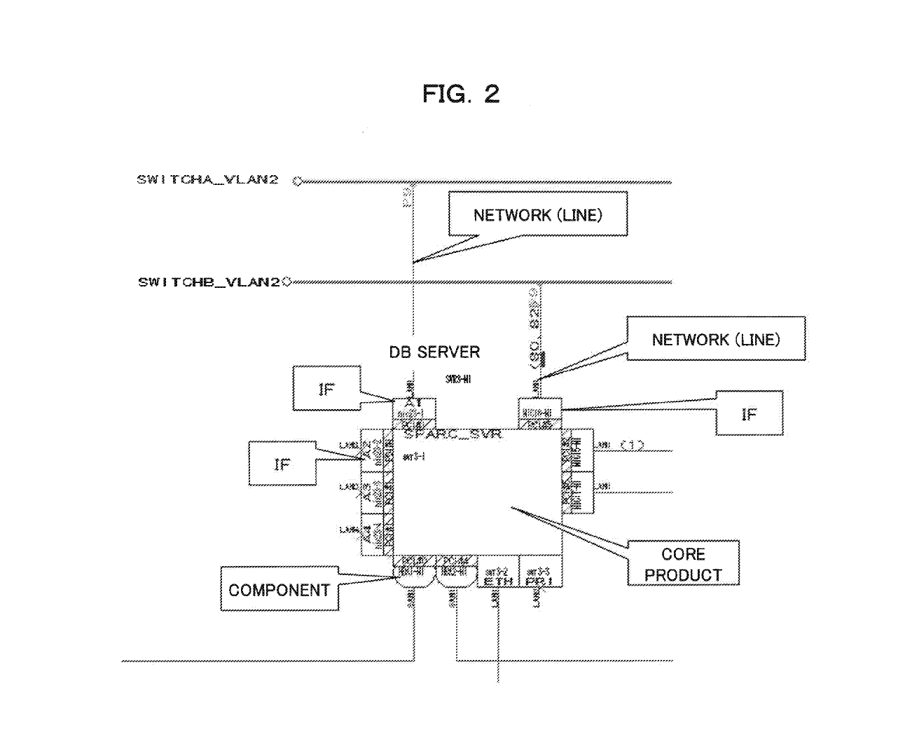

Note that, FIG. 2 is a diagram describing names in the circuit diagram of the embodiment and in the circuit diagram illustrated in FIG. 2, a part corresponding to a main body of the product (node) is depicted as a “core product” and a part which is mounted on the core product and constitutes the product (node) together with the core product is depicted as a “component”. In addition, an interface part connected to a “network (line)” for communication is depicted as “IF (interface)” in order for the core product to communicate with the outside.

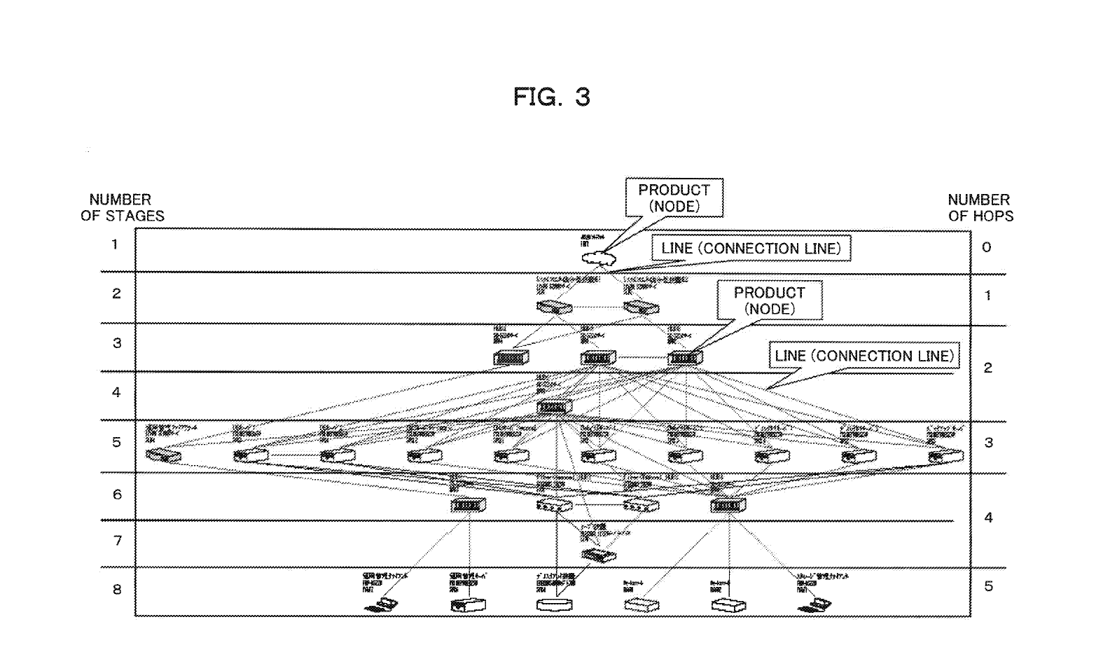

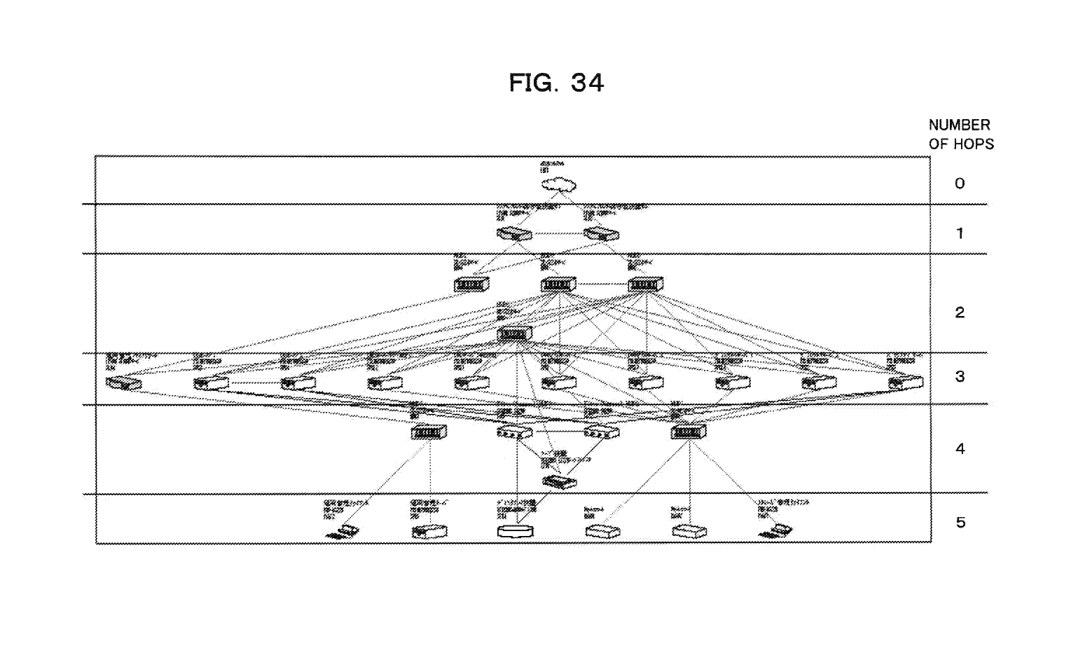

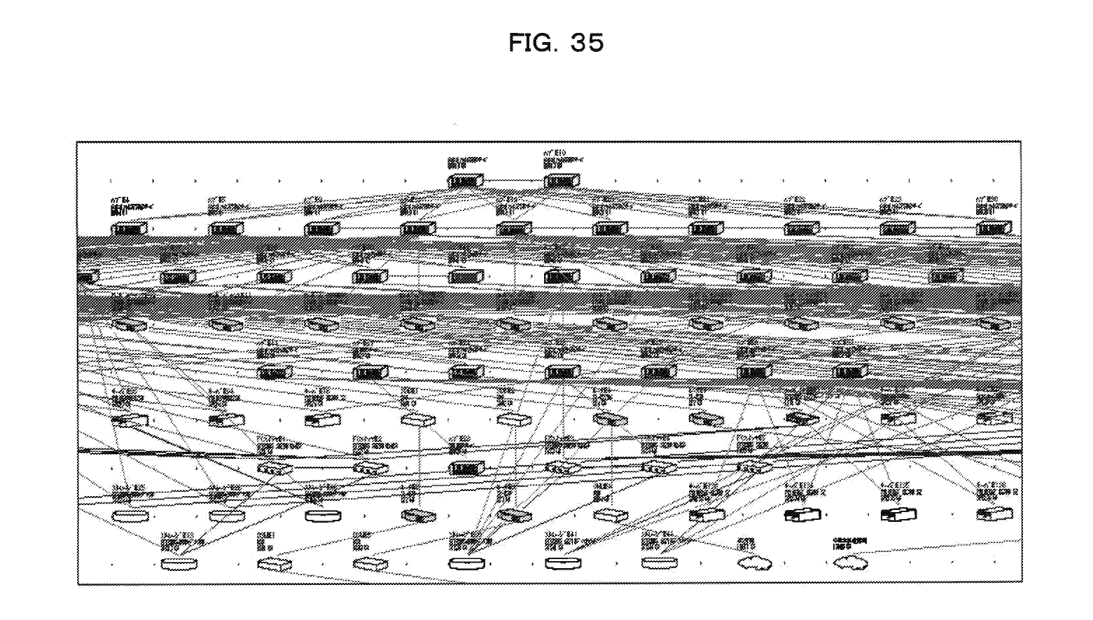

Further, FIG. 3 is a diagram describing names, the number of stages, and the number of hops (the number of connection stages) on the network schematic diagram and the “product (node)” is displayed by the node symbol which depends on a type of the product (node), on the network schematic diagram, as illustrated in FIG. 3. In addition, the products (nodes) including the connection relationship are coupled to each other by the “line (connection line)” in accordance with the network schematic diagram link data 22. Further, the number of stages of the product (node) is displayed at a left side of FIG. 3 and the number of hops is displayed at a right side of FIG. 3. On the network schematic diagram illustrated in FIG. 3, products (nodes) are displayed from first to eighth stages. In addition, the number of hops is acquired by tracing a connection relationship from a designated product by the network trace unit 31 and is the number of transfer facilities (relay nodes) via until reaching a node of a communication counterpart from the designated product. Further, on the network schematic diagram illustrated in FIG. 3, the placement processing unit 32 displays the product which is divided into upper and lower parts depending on an IF attribute even in the case of products which belong to the same number of hops as illustrated in FIG. 34 (see, for example, a product which belongs to a stage of the number of hops 2 or the number of hops 4 in FIG. 3). As a result, since the product is displayed by dividing a display stage by a connection status even in the case of the product which belongs to the same number of hops, the network schematic diagram which is easy to appreciate may be prepared and displayed.

FIG. 4 is a diagram illustrating a data structure of a network schematic diagram management table and FIG. 5 is a diagram illustrating a data structure of a product management table. The processing unit 30 (the network trace unit 31 and the placement processing unit 32) manages the network schematic diagram by using the network schematic diagram management table illustrated in FIG. 4 and prepares the network schematic diagram. Further, the processing unit 30 (the network trace unit 31 and the placement processing unit 32) manages a product (node) to be displayed on the network schematic diagram by using the product management table illustrated in FIG. 5 and prepares the network schematic diagram.

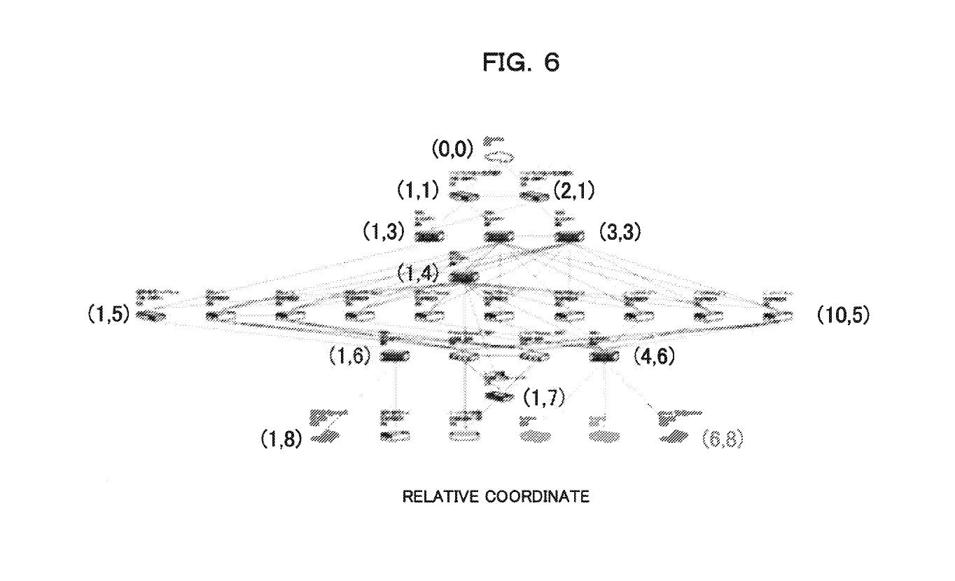

FIG. 6 is a diagram describing a coordinate on the network schematic diagram link data 22, that is, a relative coordinate on the network schematic diagram. As illustrated in FIG. 6, in the relative coordinate, a relative coordinate of a designated product (top node) is (0,0) and a relative position of each product for the designated product is used as a coordinate. For example, a relative coordinate of a leftmost product which belongs to a fifth stage (the number of hops) 3 is (1,5) and a relative coordinate of a rightmost product which belongs to the fifth stage (the number of hops 3) is (10,5).

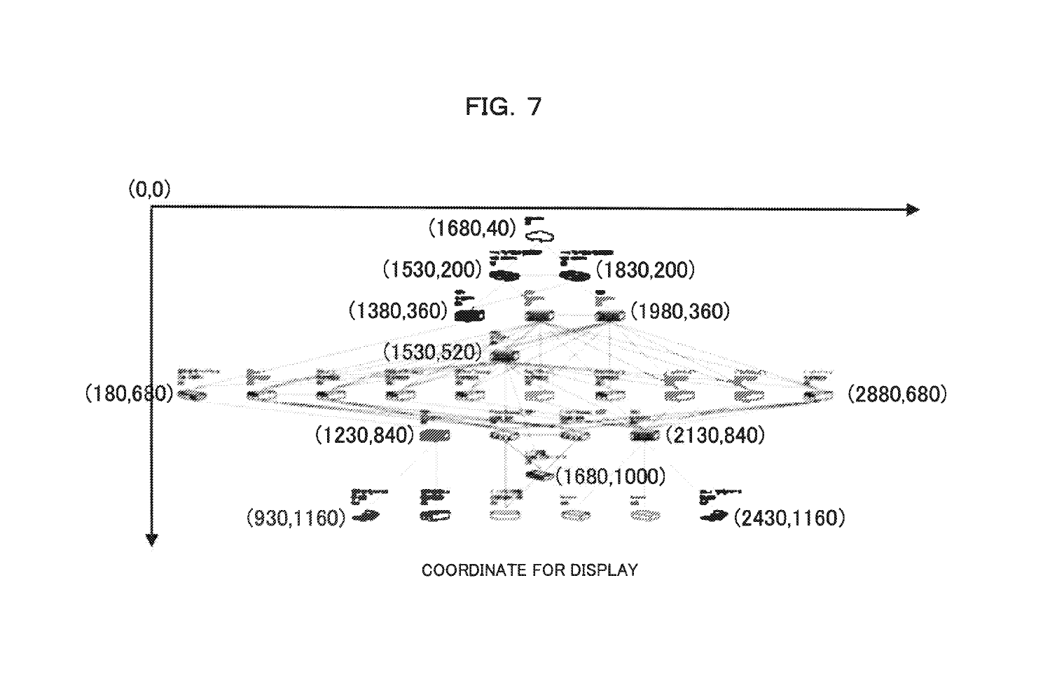

FIG. 7 is a diagram describing a coordinate on the network schematic diagram map data 23, that is, a display coordinate of the network schematic diagram. As illustrated in FIG. 7, in the display coordinate, an upper left location is set as an original point (0,0) and a position based on a distance from the original point is used as the coordinate. For example, the display coordinate of the designated product is (1680,40), the relative coordinate of the leftmost product which belongs to the fifth stage (the number of hops of 3) is (180,680), and the relative coordinate of the rightmost product which belongs to the fifth stage (the number of hops of 3) is (2880,680).

[2] Basic Preparation and Display Processing of Network Schematic Diagram by Design Supporting Apparatus

Next, by the design supporting apparatus 1 of the embodiment illustrated in FIG. 1, basic preparation display processes (b1) to (b6) of the network schematic diagram, that is, the basic processes (b1) to (b6) performed by using the functions (a1) to (a5) will be described in detail with reference to FIGS. 8 to 14.

(b1) The network trace unit 31 acquires the number of hops by tracing the connection relationship from the product designated by the operator based on the circuit diagram data 21 and keeps the network schematic diagram link data 22 in the memory 20.

(b2) The placement processing unit 32 places the designated product at the center of an uppermost stage on the network schematic diagram.

(b3) The placement processing unit 32 investigates, by using the function (a1), a link of a parent and a child by referring to the product management table to retrieve two or more products including the same connection destination and the same type among a plurality of products, on the network schematic diagram. In addition, the placement processing unit 32 displays two or more retrieved products as one representative node symbol or displays two or more retrieved products to overlap with each other (alternatively, slightly deviate from each other), on the network schematic diagram. For example, on the network schematic diagram illustrated in FIG. 3, by performing the preparation display processing, eight products which belong to the fifth stage (the number of hops of 3) are organized and displayed as four products, as illustrated in an area surrounded by a broken line A1 of FIG. 8.

(b4) Subsequently, the placement processing unit 32 does not place a node array (product display example) related to the isolated node at the central position where the designated product is placed but places and displays the node array at a position distant from the central position, on the network schematic diagram, by using the function (a2). For example, on the network schematic diagram illustrated in FIGS. 3 and 8, a left product of the third stage (an upper end of the number of hops of 2) is an isolated node connected with one lower node. When the isolated node is discovered by referring to the product management table, a node array including the isolated node or the lower node is displayed to be near to a left side of the network schematic diagram, for example, as illustrated in an area surrounded by a broken line A2 of FIG. 9. The function is implementable by assigning a relative position (see FIGS. 5 and 6) so that products which are less connected with other products, among the products which belong to the same number of hops, are at a position (outside) which is further from the central position, based on the network schematic diagram link data 22 acquired by the network trace unit 31. Note that, in the area surrounded by the dotted line A2 of FIG. 9, an arrangement processing status is illustrated after placement of the node symbols (products) in the number of all hops is completed.

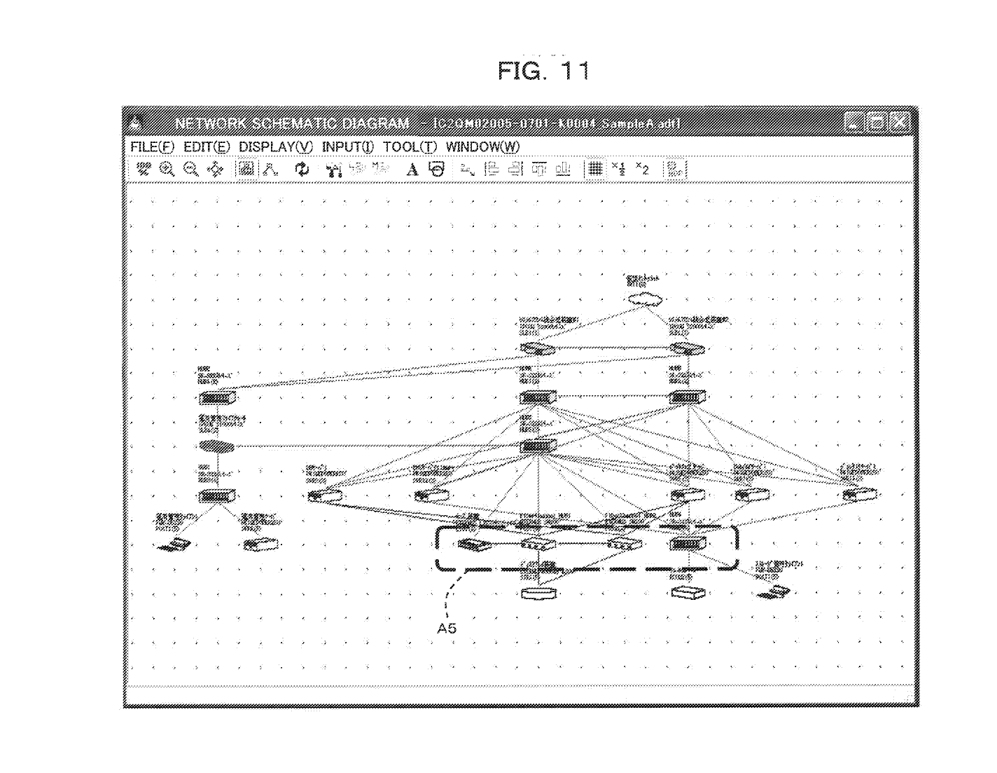

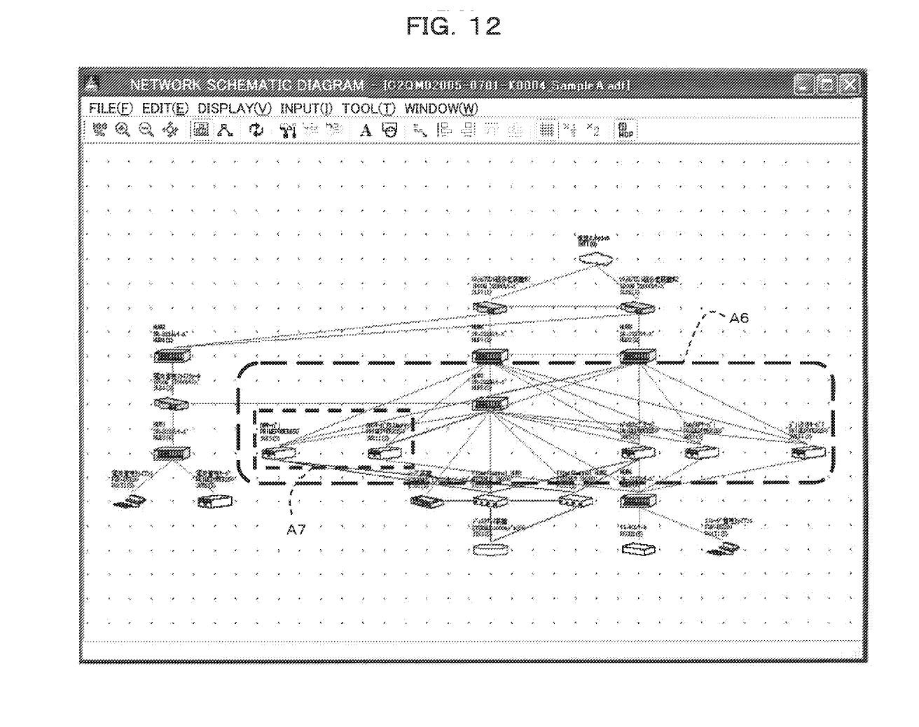

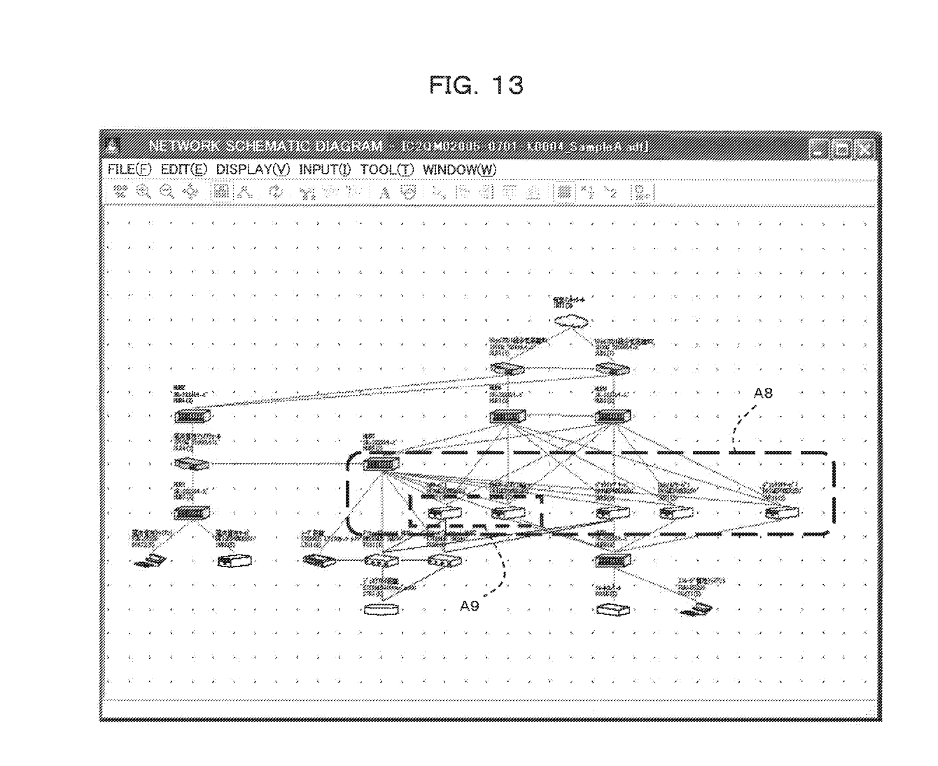

(b5) Further, the placement processing unit 32 places and displays the products which belong to the same number of hops so that the number of lines (connection lines) which cross each other is minimized, on the network schematic diagram, by using the functions (a3) to (a5). In this case, the placement processing unit 32 places and displays products which belong to the subsequent number of hops so that the number of lines which cross each other is minimized, in the case where the number of lines which cross each other is not changed even though the products which belong to the same number of hops are sorted in all methods. For example, on a network schematic diagram illustrated in FIG. 10, even though products (products which belong to the number of hops of 3) in an area surrounded by a broken line A3 are sorted with respect to products (products which belong to the number of hops of 2; the isolated node is excluded) in an area surrounded by a broken line A4 in all methods, the number of lines which cross each other is not changed. In this case, as illustrated in FIG. 11, products (products in an area surrounded by a broken line A5) which belong to the subsequent number of hops of 4 are placed so that the number of lines which cross each other is minimized. Further, as illustrated in FIG. 12, products in an area surrounded by a broken line A6 are placed so that the number of lines which cross each other is minimized. In a status illustrated in FIG. 12, the number of all crossed lines is 42, but placement for minimizing the number of crossed lines is acquired for all the lines which cross each other, and as a result, two products in an area surrounded by a broken line A7 of FIG. 12 move into an area surrounded by a dotted line A9 (in a right direction) of FIG. 13 and an area surrounded by the broken line A6 of FIG. 12 becomes a status illustrated in an area surrounded by a broken line A8 of FIG. 13.

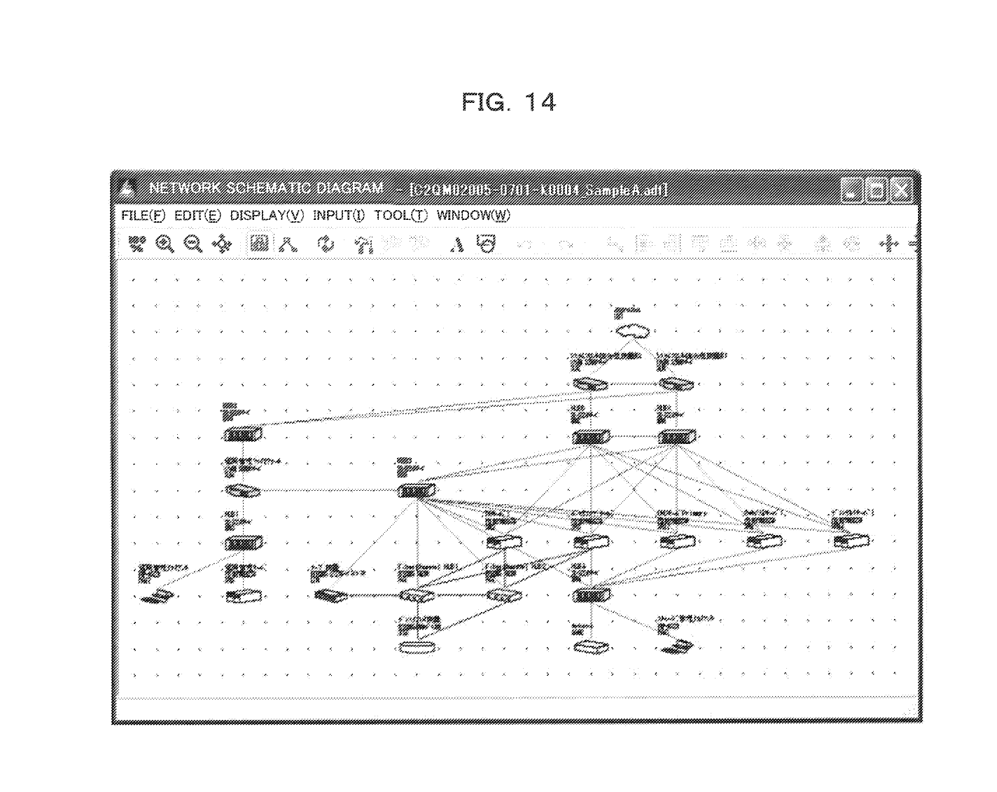

(b6) Finally, the placement processing unit 32 adjusts an interval among the products (node symbols) displayed on the network schematic diagram to finish the network schematic diagram, as illustrated in FIG. 14. In this case, the placement processing unit 32 makes vertical intervals among the products (node symbols) to be the same as each other and horizontal intervals among the products (node symbols) to be the same as each other. Further, the vertical interval and the horizontal interval may be the same value or different values.

[3] Detailed Preparation Display Procedure of Network Schematic Diagram by Design Supporting Apparatus

Next, the detailed preparation display procedure of the network schematic diagram by the design supporting apparatus 1 configured as above will be described with reference to FIGS. 15 to 31.

[3-1] Preparation Display Procedure of Network Schematic Diagram (Overall Flow; getAbstractInfo)

First, the preparation display procedure (overall flow) of the network schematic diagram by the design supporting apparatus 1 illustrated in FIG. 1 will be described in accordance with a flowchart (steps S1 to S7) illustrated in FIG. 15.

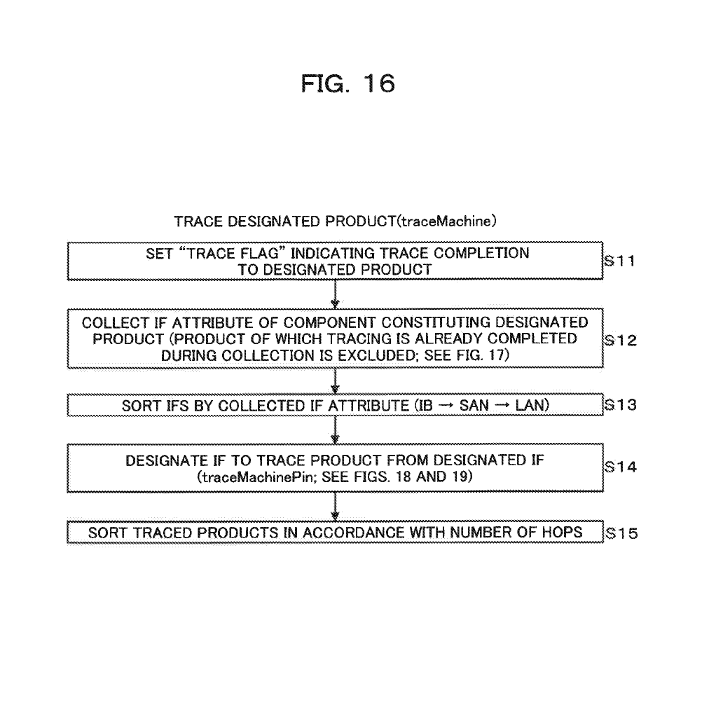

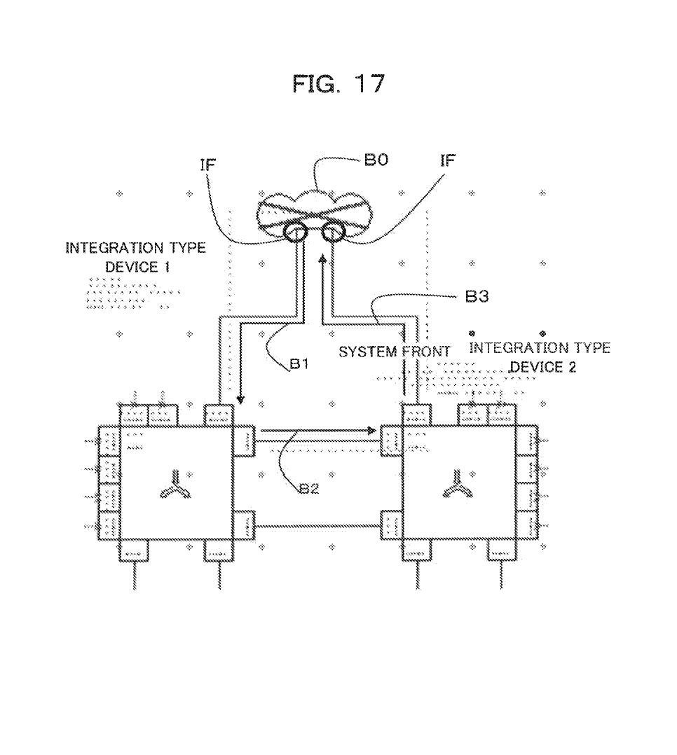

The processing unit 30 (network trace unit 31) performs tracing (traceMachine) from a product designated by an operator, based on circuit diagram data 21 (step S1). The tracing from the designated product will be described below with reference to FIGS. 16 and 17.

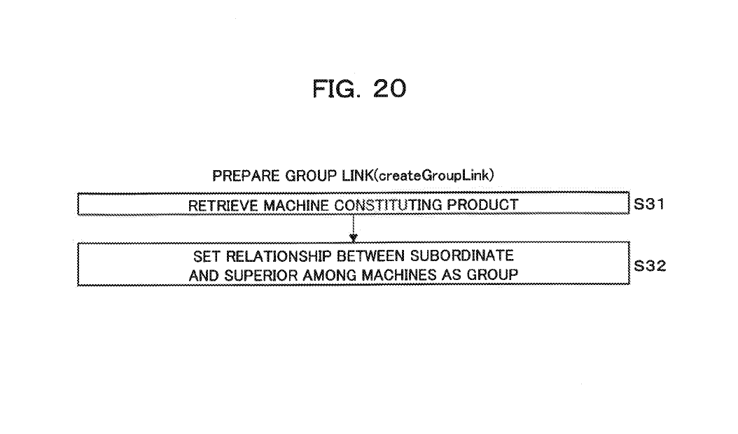

Further, the processing unit 30 (network trace unit 31) creates a group link (a parent-child relationship of the product) (createGroupLink) (step S2). The creation of the group link will be described below with reference to FIGS. 20 to 22.

A trace result or a group link creation result by the processing unit 30 (network trace unit 31) is kept in the memory 20 as the network schematic diagram link data 22.

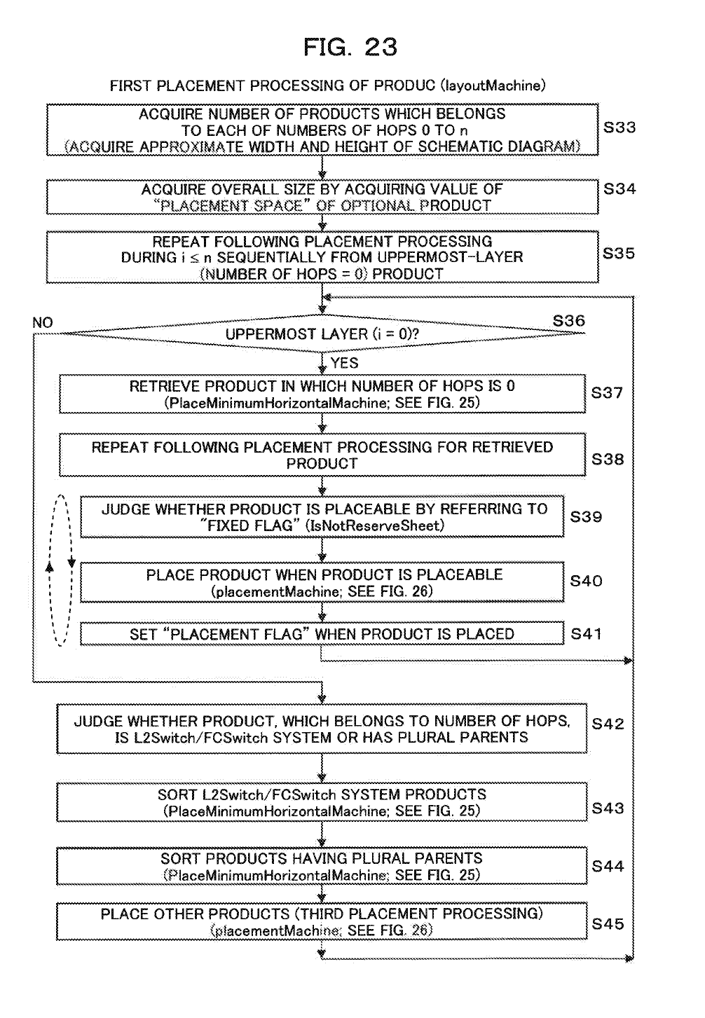

Subsequently, the processing unit 30 (placement processing unit 32) performs first placement processing of the product (layoutMachine) based on the network schematic diagram link data 22 (step S3). The first placement processing of the product will be described below with reference to FIG. 23.

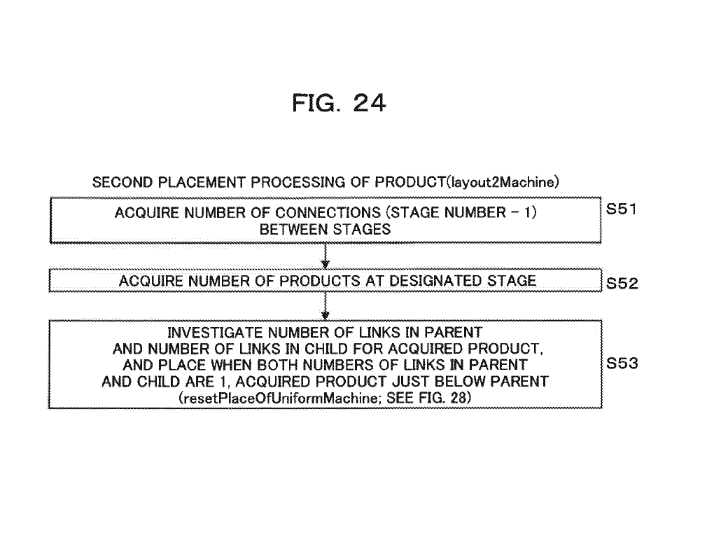

Further, the processing unit 30 (placement processing unit 32) performs second placement processing of the product (layout2Machine) such as vertical placement (step S4). The second placement processing of the product will be described below with reference to FIG. 24.

Results of the first placement processing and the second placement processing are kept in the memory 20 as the network schematic diagram map data 23.

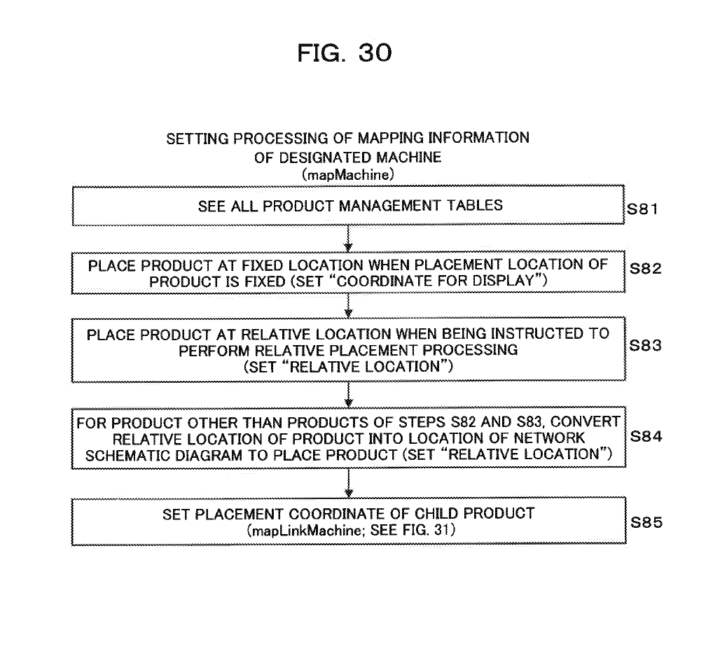

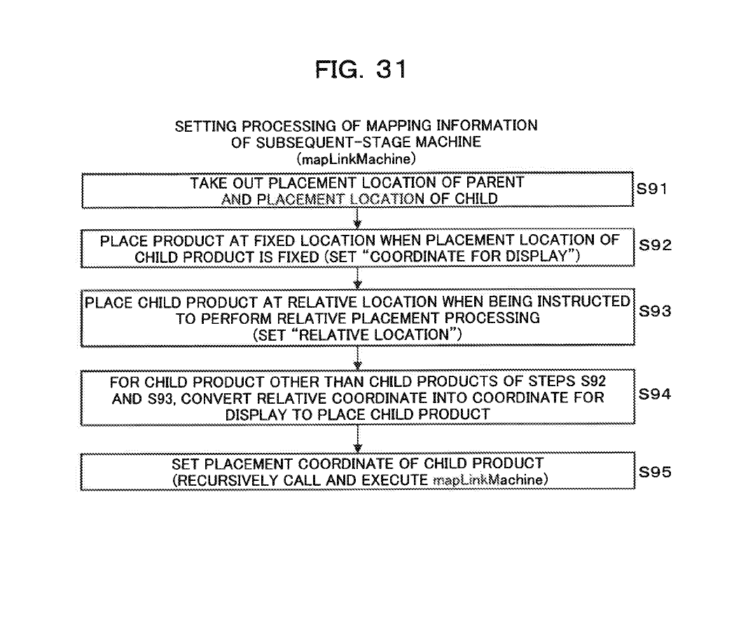

Further, the processing unit 30 (placement processing unit 32) performs mapping processing (mapMachine) and displays the network schematic diagram on the display unit 40, based on the network schematic diagram map data 23 or the product management table (step S5). Processing related to mapping will be described below with reference to FIGS. 30 and 31.

Thereafter, the processing unit 30 (placement processing unit 32) performs setting of connection information (routeMachine) (step S6). Then, the processing unit 30 (placement processing unit 32) investigates a parent-child link by referring to the product management table to retrieve two or more products being the same type and the same connection destination among a plurality of products (nodes) which belong to the same number of hops (the same number of stages) on the network schematic diagram, as described in the processing (b3). Then, the processing unit 30 (placement processing unit 32) displays two or more retrieved products as one representative node symbol or displays two or more retrieved products to overlap with each other, on the network schematic diagram (resetAbstTracePack; step S7).

[3-2] Trace Processing from Designated Product (traceMachine)

Next, trace processing (step S1) from the designated product (designated node) illustrated in FIG. 15 will be described in detail with reference to FIG. 17 in accordance with a flowchart (steps S11 to S15) illustrated in FIG. 16.

First, the processing unit 30 (network trace unit 31) sets a “trace flag” indicating tracing completion in the designated product (step S11) and thereafter, collects IF attributes of components constituting the designated product (step S12), in the product management table. In this case, for example, as illustrated in FIG. 17, when it is assumed that a product B0 is set as the designated product, the processing unit 30 (network trace unit 31) collects attributes of two IFs of the designated product B0. However, an IF attribute which has already been traced during a collection process is not collected. For example, as indicated by arrows B1, B2, and B3 of FIG. 17, in the case where tracing is performed to reach the product B0 again, the tracing-completed product B0 is excluded from a collection target so as to prevent looping.

The processing unit 30 (network trace unit 31) sorts the IFs in accordance with the collected IF attributes (InfiniBand (IB)→storage area network (SAN)→local area network (LAN); step S13).

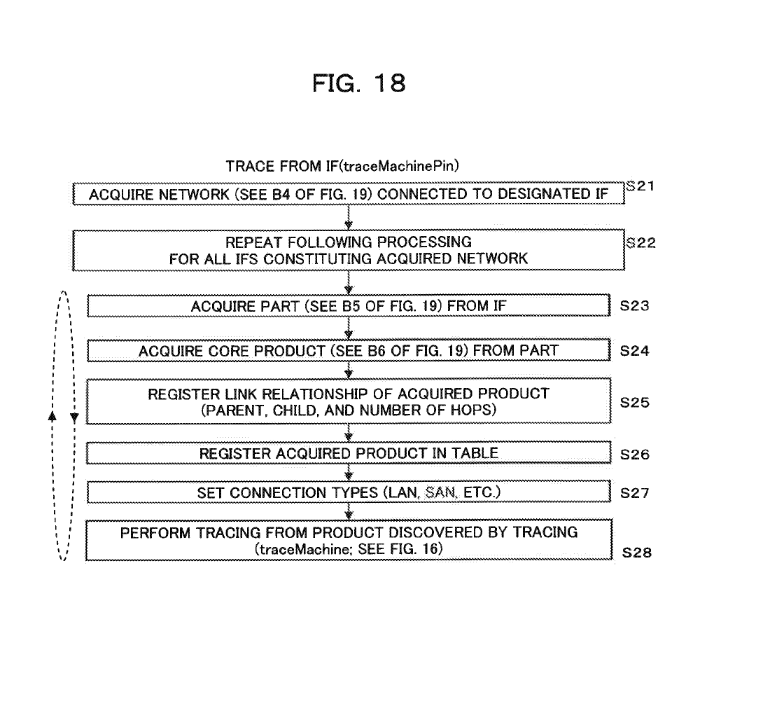

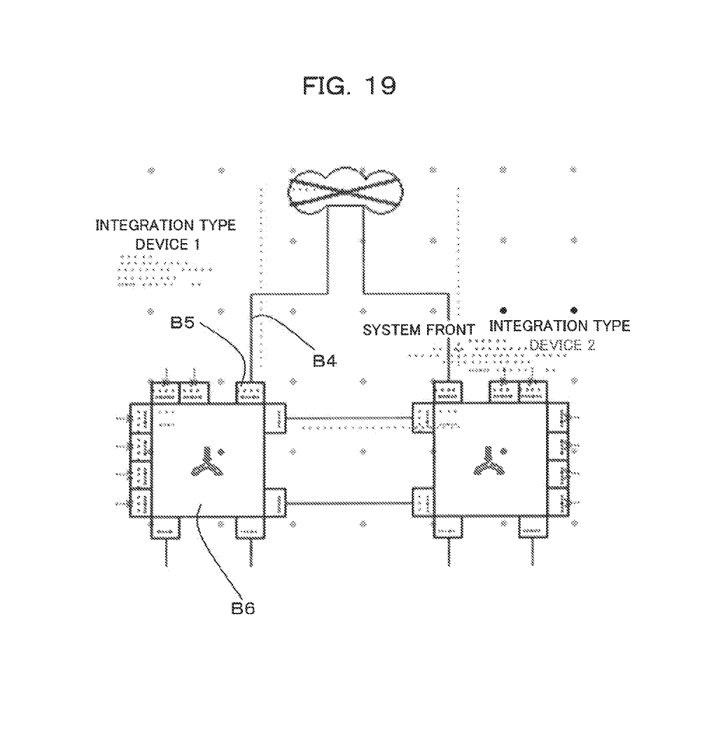

Further, the processing unit 30 (network trace unit 31) traces the product from the designated IF by designating the IF (traceMachinePin; step S14). The trace processing from the designated IF will be described below with reference to FIGS. 18 and 19.

Then, the processing unit 30 (network trace unit 31) sorts the traced products in accordance with the number of hops (step S15) and terminates the trace processing from the designated product.

[3-3] Trace Processing from IF (traceMachinePin)

Next, the processing (step S14) of tracing the product from the IF illustrated in FIG. 16 will be described in detail with reference to FIG. 19 in accordance with a flowchart (steps S21 to S28) illustrated in FIG. 18.

The processing unit 30 (network trace unit 31) acquires a network (see, for example, a network B4 of FIG. 19) connected to the designated IF (step S21). The processing unit 30 (network trace unit 31) repeatedly executes processing of steps S23 to S28 described below for all IFs constituting the acquired network (step S22).

Further, the processing unit 30 (network trace unit 31) acquires a component (see, for example, a component B5 of FIG. 19) from the IF (step S23) and acquires a core product (see, for example, a core product B6 of FIG. 19) from the acquired component (step S24). In addition, the processing unit 30 (network trace unit 31) registers a link relationship (parent, child, and the number of hops) of the acquired product in the product management table of the memory 20, or the like (step S25), registers the acquired product in the table (step S26), and sets a connection type (the LAN, the SAN, or the like) (step S27). Then, the processing unit 30 (network trace unit 31) performs the trace processing illustrated in FIG. 16 from the product discovered by the trace (step S28).

[3-4] Group Link Preparation Processing (createGroupLink)

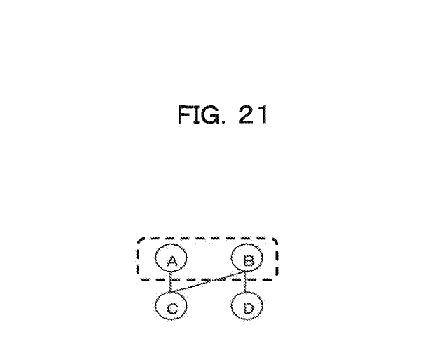

Next, the creation processing (step S2) from the group link (the parent-child relationship) illustrated in FIG. 15 will be described in detail with reference to FIG. 21 in accordance with the flowchart (steps S31 to S32) illustrated in FIG. 20.

The processing unit 30 (network trace unit 31) retrieves machines constituting the product (step S31) and groups a vertical relationship among the machines (step S32). Specifically, the processing unit 30 (network trace unit 31) extracts a product including a plurality of parents while sequentially pursuing the “product management table” (see FIG. 5) linked to “all generated products” of the “network schematic diagram management table” (see FIG. 4) of the data structure, and assigns the group link (the “group link” of the “product management table”) to the parent. As a result, the group link (the parent-child relationship of the product) is created. For example, as illustrated in FIG. 21, the parent-child relationship between a product A and a product C and the parent-child relationship between a product B and a product D are determined by the trace, but since it has not been known that the two products A and B are parents of the product C, a link indicating that the two products A and B are the parents of the product C is assigned by the group link preparation processing.

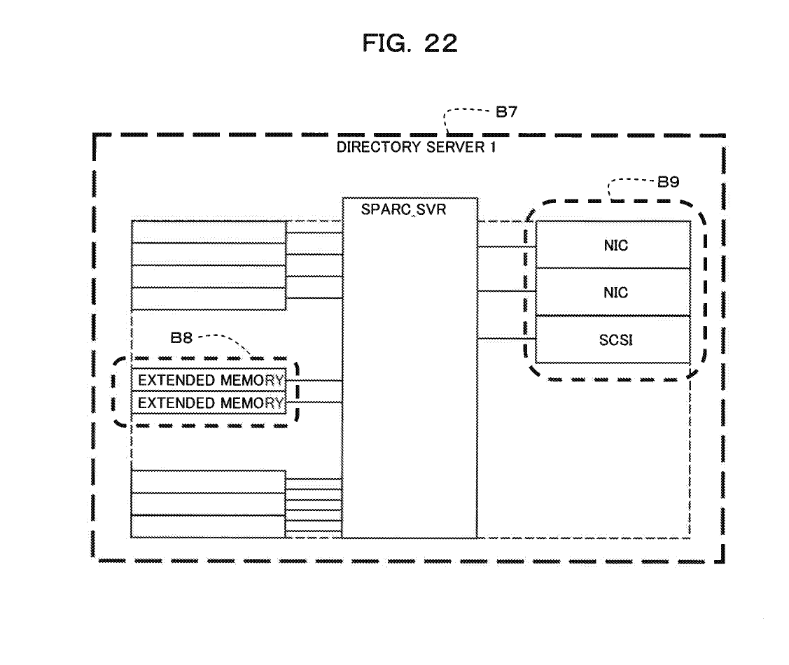

Herein, concepts of the product and the machine will be described with reference to FIG. 22.

The “product” is a minimized unit of purchased as the product. In FIG. 22, a main body denoted by reference numeral B7 and extended memories denoted by reference numerals B8 and B9, a network interface card (NIC), and a small computer system interface (SCSI) card correspond to the “product”. Further, the “machine” is a unit in which the “products” are collected to be integrally managed. In addition, the “component” is each part constituting the “product” and is not generally purchased as a single item.

[3-5] First Placement Processing of Product (layoutMachine)

Next, the first placement processing (step S3) of the product illustrated in FIG. 15 will be described in detail in accordance with a flowchart (steps S33 to S45) illustrated in FIG. 23.

The processing unit 30 (placement processing unit 32) acquires the number of products which belong to each of the numbers of hops of 0 to n (n=5 in the example illustrated in FIG. 3) (step S33). As a result, an approximate width and an approximate height of the network schematic diagram are acquired. Further, the processing unit 30 (placement processing unit 32) acquires an overall size of the network schematic diagram by acquiring a value set as a “placement space” (the height of a row and the width of a column) of the product in an “option” displayed on a pop-up screen (step S34).

The processing unit 30 (placement processing unit 32) repeatedly executes first placement processing (steps S36 to S45) described below sequentially from an uppermost product (the number of hops=0) during i≦n (step S35). Note that, i denotes the number of hops of a processing target.

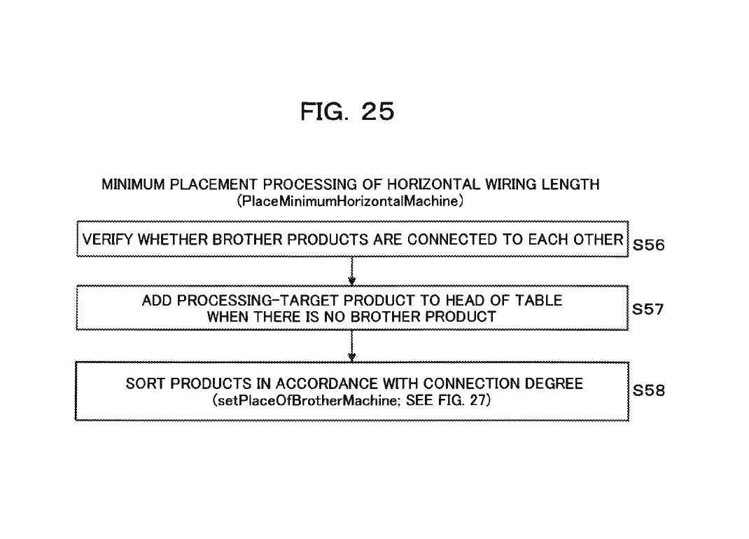

When the number of hops of the processing target, i is 0 (uppermost) (route YES of step S36), the processing unit 30 (placement processing unit 32) retrieves a product including the number of hops of 0 (PlaceMinimumHorizontalMachine; step S37). The processing in step S37 will be described below with reference to FIG. 25.

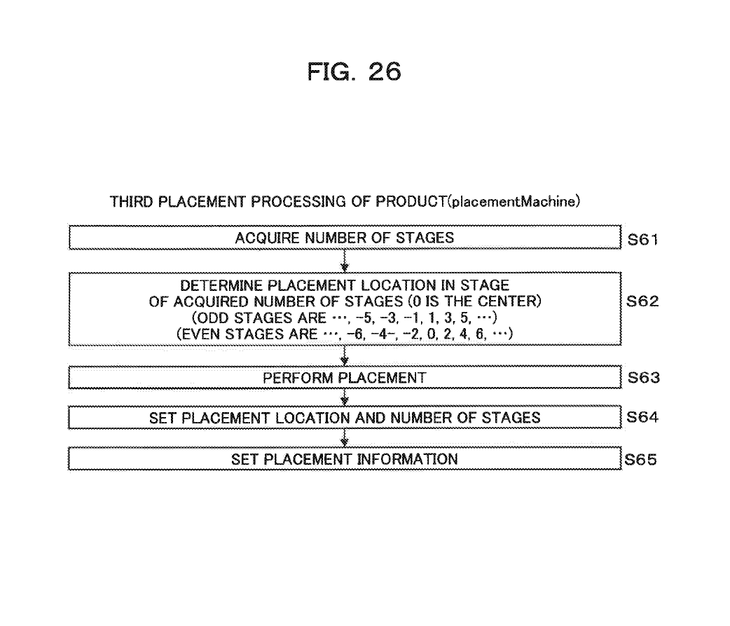

The processing unit 30 (placement processing unit 32) repeatedly executes placement processing (steps S39 to S41) described below for the product retrieved in step S37 (step S38). First, the processing unit 30 (placement processing unit 32) judges whether the retrieved product is placeable by referring to a “fixed flag” of the product management table (IsNotReserveSheet; step S39). When the retrieved product is placeable, the processing unit 30 (placement processing unit 32) places the product (placementMachine; step S40). The placement processing performed herein will be described below with reference to FIG. 26. Further, the processing unit 30 (placement processing unit 32) sets a “placement flag” of the product management table when the product is placed (step S41). When the placement processing is completed for the product retrieved in step S37, the processing unit 30 (placement processing unit 32) sets the number of hops of the processing target, i as i+1 and thereafter, the process returns to the processing of step S36.

On the other hand, when the number of hops of the processing target, i is not 0 (uppermost) (route NO of step S36), the processing unit 30 (placement processing unit 32) first judges whether a product which belongs to the number of hops of the processing target is an L2Switch system or an FCSwitch system and judges whether the product which belongs to the number of hops of the processing target has a plurality of parents (step S42). Judging whether the product is the L2Switch system or the FCSwitch system is performed based on whether a “merchandise functional classification” of the product in the product management table is “HUB” or “HUBM”.

Thereafter, the processing unit 30 (placement processing unit 32) sorts the L2Switch-system product and the FCSwitch-system product (PlaceMinimumHorizontalMachine; step S43). The processing in step S43 will be described below with reference to FIG. 25.

Further, the processing unit 30 (placement processing unit 32) sorts the products including the plurality of parents (PlaceMinimumHorizontalMachine; step S44). The processing in step S44 will be described below with reference to FIG. 25.

Further, the processing unit 30 (placement processing unit 32) performs placement processing (third placement processing) of other products (placementMachine; step S45) and thereafter, sets the number of hops of the processing target, as i+1 and in the case where the number of hops of a new processing target is n or less, the process returns to the processing of step S36, while in the case where the number of hops of the new processing target is more than n, the process ends. Note that, the processing in step S45 will be described below with reference to FIG. 26.

Herein, the reason for performing the processing in the order of placement (sorting) of the L2Switch-system product and the FCSwitch-system product, placement (sorting) of the product including the plurality of parents, and placement of other products is as follows.

That is, the reason for first placing hub-system products is that an image in which the product is hung below the hub may be clearly expressed and the products may be efficiently placed, by placing the products while the product has not yet been placed. When the hub-system product is placed after other products are placed, the hub-system product needs to be placed by avoiding other products which are placed in advance and the placement of the hub-system products are skipping, and as a result, the image in which the product is hung below the hub is damaged, and thus the product may not be efficiently placed.

Further, since it is considered that the product including the plurality of parents may be placed to be adjacent to each other comparatively simply than the hub-system product, while it is considered that it is desirable to place the product more carefully than a product including one parent, and thus the product including the plurality of parents is placed subsequently to the hub-system product.

Then, since other products are just placed immediately below the parent, the other products may be placed last and not a method of performing complicated placement processing but a method of simple placement processing is adopted.

Note that, in the case where the L2Switch-system product and the FCSwitch-system product, and other products coexist in a stage of the same number of hops coexist, it is preferable to place the L2Switch-system product and the FCSwitch-system product to be divided into two stages so that the L2Switch-system product and the FCSwitch-system product are above the other products, for improving an exterior of the network schematic diagram.

Further, the processing in steps S37, S43, and S44 (PlaceMinimumHorizontalMachine; see FIG. 25) is to just sort the products and processing of actually placing the products is performed in steps S40 and S45 (placementMachine; see FIG. 26).

[3-6] Second Placement Processing of Product (layout2Machine)

Next, the second placement processing (step S4) of the product illustrated in FIG. 15 will be described in detail in accordance with a flowchart (steps S51 to S53) illustrated in FIG. 24.

The processing unit 30 (placement processing unit 32) acquires the number of connections (the number of states—1) among stages (step S51) and acquires the number of products which belong to a designated stage (step S52). Herein, the “number of stages” is displayed at the left side of FIG. 3 and in the example illustrated in FIG. 3, since the number of stages is 8, the number of connections among the stages is 7.

Thereafter, the processing unit 30 (placement processing unit 32) investigates the number of links to the parent and the number of links to the child in the product management table for the acquired product and when any one of both sides is 1, the product is placed immediately below the parent product (resetPlaceOfUniformMachine; step S53). As a result, product placement seriously considering the exterior may be performed.

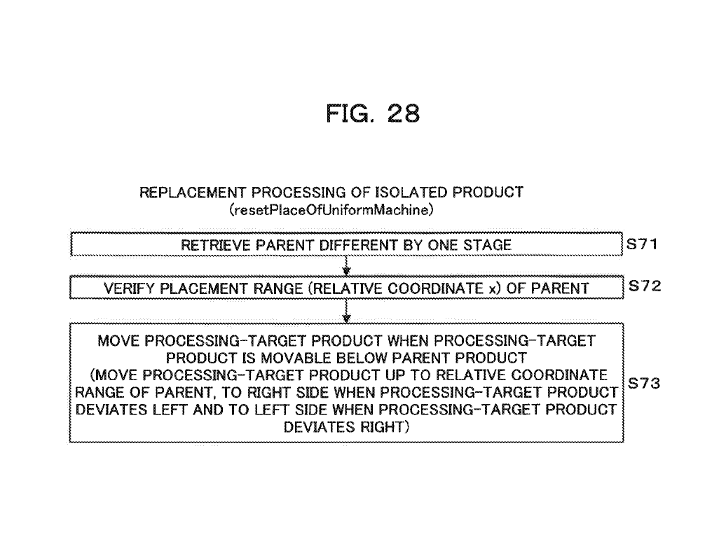

Note that, the processing in step S53 will be described below with reference to FIG. 28.

In addition, the number of links to the parent and the number of links to the child are set in a “parent link” and a “child link” of the product management table (see FIG. 5), respectively.

[3-7] Minimized Placement Processing of Horizontal Wire Length (PlaceMinimumHorizontalMachine)

Next, the horizontal placement processing (steps S37, S43, and S44) of the product illustrated in FIG. 23 will be described in detail in accordance with a flowchart (steps S56 to S58) illustrated in FIG. 25.

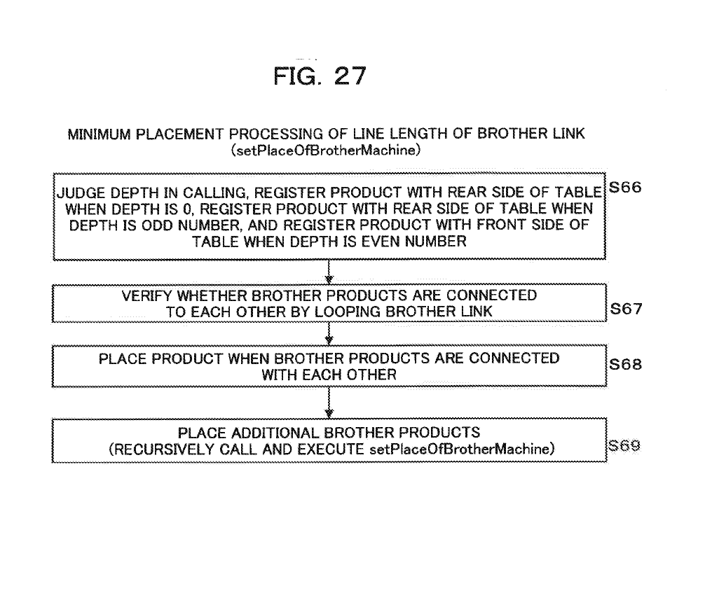

The processing unit 30 (placement processing unit 32) recognizes whether brother products (that is, products which belong to a stage of the same number of stages) are connected with each other for a processing target product (step S56) and adds the processing target product to a head of the table when there is no brother product (step S57). Then, the processing unit 30 (placement processing unit 32) sorts the products by connectivity (setPlaceOfBrotherMachine; step S58). As a result, placement processing is performed so that the horizontal wire length is minimized. Note that, the processing in step S58 will be described below with reference to FIG. 27.

[3-8] Third Placement Processing of Product (placementMachine)

Next, the third placement processing (steps S40 and S45) of the product illustrated in FIG. 23 will be described in detail in accordance with a flowchart (steps S61 to S65) illustrated in FIG. 26.

The processing unit 30 (placement processing unit 32) first acquires the number of stages of the processing target product (see the left side of FIG. 3) (step S61) and determines the placement position in a stage of the acquired number of stages (step S62). Herein, on the network schematic diagram, a relative placement position of an odd stage is determined from . . . , −5, −3, −1, 1, 3, 5, . . . and a relative placement position of an even stage is determined from . . . , −6, −4-, −2, 0, 2, 4, 6, . . . , for example, by centering 0, in order to place the products in a check lattice shape, as illustrated in FIG. 3.

Thereafter, the processing unit 30 (placement processing unit 32) places the processing target product at a determined position (step S63), and sets the placed position and the number of stages (step S64) and sets placement information in the product management table (step S65). Herein, the placement information corresponds to “any one of left and right sides from a start point of a trace” in the product management table (FIG. 5), and a value set in “any one of the left and right sides from the start point of the trace” is three types of a “center”, a “left side”, and a “right side” and is used in the processing (layoutMachine) illustrated in FIG. 23.

[3-9] Minimized Placement Processing of Line Length Of Brother Link (setPlaceOfBrotherMachine)

Sorting processing of the products illustrated in FIG. 25 (step S58) will be described in detail in accordance with a flowchart (steps S66 to S69) illustrated in FIG. 27. Herein, the brother link corresponds to a “brother link of the same number of hops” in the product management table (see FIG. 5).

The processing unit 30 (placement processing unit 32) first judges a depth in calling the processing target product, registers the processing target product in the rear of the table in the case where the depth is 0, and registers the processing target product in the rear of the table in the case where the depth is an odd number and registers the processing target product in front of the table in the case where the depth is an even number (step S66). Further, the processing unit 30 (placement processing unit 32) verifies whether the brother products (that is, the products which belong to a stage of the same number of stages) are connected with each other by looping the brother link (step S67) and places the processing target product when the brother products are connected with each other (step S68). In addition, the processing unit 30 (placement processing unit 32) recursively calls and executes the processing (setPlaceOfBrotherMachine) to place additional brother products (step S69). As a result, the product placement is performed so that the line length is minimized along the brother link.

Herein, in step S66, the reason for changing a registration position of the product in the table to any one of front and rear of the table depending on the depth is as follows.

(1) When the first product A is registered, “A” is registered in the table.

(2) Next, when the product B is registered, the products are registered in the table in the order of “A→B”.

(3) Next, when the product C is registered, the products are registered in the table in the order of “C→A→B”.

(4) Next, when the product D is registered, the products are registered in the table in the order of “C→A→B→D”.

As a result, the reason is that the subsequent products B, C, D, . . . , are alternately registered in front of and in the rear of the table by centering the first product A and the length of the connection line between the brother products which are connected with each other is automatically decreased. When the products are taken out from the head of the table to be placed at the time of placing the products, the products are placed to be adjacent to each other.

[3-10] Reset Placement Processing of Uniform Product (resetPlaceOfUniformMachine)

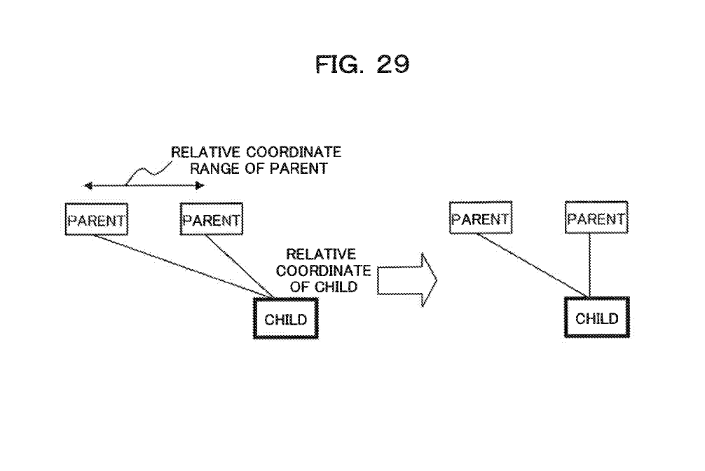

Placement processing of the isolated node illustrated in FIG. 24 (the reset placement processing of the uniform product; step S53) will be described in detail with reference to FIG. 29, in accordance with a flowchart (steps S71 to S73) illustrated in FIG. 28.

The processing unit 30 (placement processing unit 32) retrieves a parent distant from the processing target product by one stage (step S71) and verifies a placement range (relative coordinate x) of the retrieved parent (step S72). Then, the processing unit 30 (placement processing unit 32) moves the processing target product when the processing target product is movable to a lower side of the parent product (step S73). For example, as illustrated in FIG. 29, when the processing target product (child product) deviates right from the parent product, the processing unit 30 moves the processing target product up to the relative coordinate range of the parent in a left direction. On the contrary, when the processing target product deviates left from the parent product, the processing unit 30 moves the processing target product up to the relative coordinate range of the parent in a right direction. As a result, reset placement of the uniform product (isolated node) including the plurality of parent products is performed.

[3-11] Setting Processing of Mapping Information of Designated Machine (mapMachine)

Mapping processing illustrated in FIG. 15 (step S5) will be described in detail in accordance with a flowchart (steps S81 to S85) illustrated in FIG. 30.

The processing unit 30 or the display unit 40 places and displays the products at fixed positions in the case where the placement positions of the products are fixed by referring to all product management tables related to the designated machine (step S81) (setting a “display coordinate”; step S82). Further, the processing unit 30 or the display unit 40 places and displays the products at relative positions when receiving a relative placement instruction (setting a “relative position”; step S83). The processing of step S83 corresponds to processing in the case where the “placement space” of the product is changed in the “option” displayed through the pop-up screen.

Then, in the case of products other than the cases of steps S82 and S83, the processing unit 30 or the display unit 40 converts relative positions of the products to positions of the network schematic diagram, and places and displays the products at positions after conversion (setting the “relative position”; step S84).

Further, the processing unit 30 or the display unit 40 sets a placement coordinate of the child product of the processing target product (step S85). The processing in step S85 will be described below with reference to FIG. 31. As a result, the mapping information of the designated machine is set.

[3-12] Setting Processing of Mapping Information of Subsequent-Stage Machine of Designated Machine (mapLinkMachine)

Setting processing of the placement coordinate of the child illustrated in FIG. 30 (step S85) will be described in detail in accordance with a flowchart (steps S91 to S95) illustrated in FIG. 31.

The processing unit 30 or the display unit 40 takes out the placement position of the parent product and the placement position of the child product (step S91), and places and displays the child product at a fixed position in the case where the placement position of the child product is fixed (setting the “display coordinate”; step S92). Further, the processing unit 30 or the display unit 40 places and displays the child product at a relative position when receiving a relative placement instruction (setting the “relative position”; step S93). The processing of step S93 corresponds to processing in the case where the “placement space” of the child product is changed in the “option” displayed through the pop-up screen.

Then, in the case of the child product other than the cases of steps S92 and S93, the processing unit 30 or the display unit 40 converts the relative position of the child product to the position of the network schematic diagram, and places and displays the child product at a position after conversion (setting the “relative position”; step S94).

Further, the processing unit 30 or the display unit 40 sets a placement coordinate of the processing target child product (step S95). In this case, the processing unit 30 or the display unit 40 recursively calls and executes the processing (mapLinkMachine). As a result, mapping information of a machine connected to a subsequent stage of the designated machine is set.

[4] Operational Effect of Design Supporting Apparatus

According to the design supporting apparatus 1 of the embodiment, two or more products being the same type and the same connection destination are displayed as one representative node or displayed to overlap with each other (alternatively, slightly deviate from each other), on the network schematic diagram. As a result, the number of displayed products or connection lines (lines) in which the connection relationships are duplicated is reduced to thereby prevent the lines among the products from complicatedly crossing each other. Accordingly, the network schematic diagram is simplified, and as a result, viewability of the network schematic diagram is improved and it is very easy to appreciate the connection relationship of the products.

Further, according to the design supporting apparatus 1 of the embodiment, on the network schematic diagram, with respect to an isolated node connected with one lower node, the lower node is placed and displayed immediately below the isolated node and further, a node array including the isolated node and the lower node is placed and displayed at a position distant from a central position where a designated product is placed. As a result, since the isolated node is isolated from a node group, the viewability of the network schematic diagram is further improved.

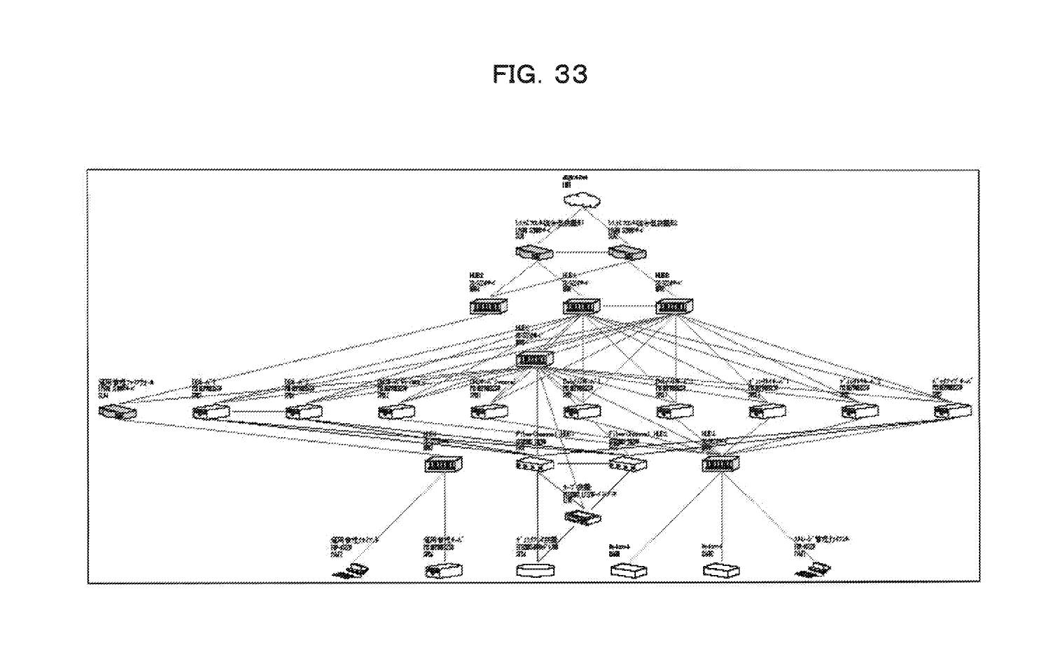

For example, in the related method, when the network schematic diagram prepared and displayed as illustrated in FIG. 33 is applied to the design supporting apparatus 1 of the embodiment, the network schematic diagram is prepared and displayed as illustrated in FIG. 14, and as a result, distinctly, the network schematic diagram is simplified, and as a result, the viewability of the network schematic diagram is improved and it is easy to appreciate the connection relationship of the products.

According to the embodiment, the viewability of the network schematic diagram is improved.

[5] Others

As described above, although the preferred embodiment of the invention has been described above, the invention is not limited to the specific embodiment and various modifications and changes can be made within the scope without departing from the spirit of the invention.

Note that, the design supporting apparatus 1 of the embodiment may further include a function to hold a plurality of network schematic diagrams at a time of an edition process in terms of a snapshot and a function to appropriately extract the held network schematic diagram in terms of a snapshot, in addition to the function to prepare the network schematic diagram. As a result, convenience in preparing the network schematic diagram may be improved.

The computer (including the CPU, an information processing apparatus, and various terminals) executes a predetermined application program (design support program) to implement all or some of the functions as the preparation unit 30, the network trace unit 31, and the placement processing unit 32.

The program is provided in a format recorded in computer-readable recording media such as a flexible disk, a CD (CD-ROM, CD-R, CD-RW, or the like), a DVD (DVD-ROM, DVD-RAM, DVD-R, DVD-RW, DVD+R, DVD+RW, or the like), a Blu-ray disk. In this case, the computer reads a program from the recording medium, and transmits and stores the read program to and in an internal storage device or an external storage device, and then uses the program.

Herein, the computer is a concept including hardware and an operating system (OS) and means hardware which operates under a control from the OS. Further, when the OS is unnecessary and an application program singly operates the hardware, the hardware itself corresponds to the computer. The hardware at least includes a microprocessor such as the CPU and method for reading a computer program recorded in the recording medium. The design support program includes a program code which makes the computer as described above to implement the functions as the preparation unit 30, the network trace unit 31, and the placement processing unit 32. Further, some of the functions may be implemented not by the application program but by the OS.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A computer-readable recording medium having stored therein a design support program for causing, to execute a process, a computer that prepares a network schematic diagram indicating a connection relationship of nodes in a subordinate of a designated node among a plurality of nodes, based on circuit diagram information related to the plurality of nodes constituting a network, the process comprising:
displaying two or more nodes, in which connection destination nodes are the same as each other while types are the same as each other, among the plurality of nodes as one representative node or displaying two or the more nodes to overlap with each other, on the network schematic diagram.

2. The computer-readable recording medium according to claim 1, the process comprising:
placing and displaying, on the network schematic diagram, with respect to an isolated node, to which one lower node is connected, among the plurality of nodes, the lower node just below the isolated node.

3. The computer-readable recording medium according to claim 2, the process comprising:
placing and displaying, on the network schematic diagram, the designated node at the center of an uppermost stage, and
placing and displaying, on the network schematic diagram, a node array including the isolated node and the lower node at a location spaced apart from a central location at which the designated node is placed.

4. The computer-readable recording medium according to claim 1, the process comprising:
displaying, on the network schematic diagram, the connection relationship in a tree form considering the number of connection stages from the designated node by using node symbols corresponding to the plurality of nodes, respectively and a connection line for coupling the node symbols having the connection relationship with each other.

5. The computer-readable recording medium according to claim 4, the process comprising:
placing and displaying, on the network schematic diagram, nodes in a same connection stage so that the number of connection lines that cross each other is minimum.

6. The computer-readable recording medium according to claim 5, the process comprising:
placing and displaying, on the network schematic diagram, in the case where the number of connection lines that cross each other is not changed even though the nodes in the same connection stage are sorted, nodes in a subsequent connection stage so that the number of connection lines that cross each other is minimum.

7. A design supporting apparatus, comprising:
a storage unit storing circuit diagram information related to a plurality of nodes constituting a network;
a processor preparing a network schematic diagram indicating a connection relationship of nodes in a subordinate of a designated node among the plurality of nodes, based on the circuit diagram information stored in the storage unit,
wherein the processor
displays two or more nodes, in which connection destination nodes are the same as each other while types are the same as each other, among the plurality of nodes as one representative node or displays the two or more nodes to overlap with each other, on the network schematic diagram.

8. The design supporting apparatus according to claim 7, wherein:
the processor
places and displays, on the network schematic diagram, with respect to an isolated node, to which one lower node is connected, among the plurality of nodes, the lower node just below the isolated node.

9. The design supporting apparatus according to claim 8, wherein:
the processor
places and displays, on the network schematic diagram, the designated node at the center of an uppermost stage, and
places and displays, on the network schematic diagram, a node array including the isolated node and the lower node at a location spaced apart from a central location at which the designated node is placed.

10. The design supporting apparatus according to claim 7, wherein:
the processor
displays, on the network schematic diagram, the connection relationship in a tree form considering the number of connection stages from the designated node by using node symbols corresponding to the plurality of nodes, respectively and a connection line for coupling the node symbols having the connection relationship with each other.

11. The design supporting apparatus according to claim 10, wherein:
the processor
places and displays, on the network schematic diagram, nodes in a same connection stage so that the number of connection lines that cross each other is minimum.

12. The design supporting apparatus according to claim 11, wherein:
the processor
places and displays, on the network schematic diagram, in the case where the number of connection lines that cross each other is not changed even though the nodes in the same connection stage are sorted, nodes in a subsequent connection stage so that the number of connection lines that cross each other is minimum.

13. A design supporting method of preparing a network schematic diagram indicating a connection relationship of nodes in a subordinate of a designated node among a plurality of nodes, based on circuit diagram information related to the plurality of nodes constituting a network, the method comprising:
displaying two or more nodes, in which connection destination nodes are the same as each other while types are the same as each other, among the plurality of nodes as one representative node or displaying the two or more nodes to overlap with each other, on the network schematic diagram.

14. The design supporting method according to claim 13, the method further comprising:
placing and displaying, on the network schematic diagram, with respect to an isolated node, to which one lower node is connected, among the plurality of nodes, the lower node just below the isolated node.

15. The design supporting method according to claim 14, the method further comprising:
placing and displaying, on the network schematic diagram, the designated node at the center of an uppermost stage and a node array including the isolated node, and
placing and displaying, on the network schematic diagram, the lower node at a location spaced apart from a central location at which the designated node is placed.

16. The design supporting method according to claim 13, the method further comprising:
displaying, on the network schematic diagram, the connection relationship in a tree form considering the number of connection stages from the designated node by using node symbols corresponding to the plurality of nodes, respectively and a connection line for coupling the node symbols having the connection relationship with each other.

17. The design supporting method according to claim 16, the method further comprising:
placing and displaying, on the network schematic diagram, nodes in a same connection stage so that the number of connection lines that cross each other is minimum.

18. The design supporting method according to claim 17, the method further comprising:
placing and displaying, on the network schematic diagram, in the case where the number of connection lines that cross each other is not changed even though the nodes in the same connection stage are sorted, nodes in a subsequent connection stage so that the number of connection lines that cross each other is minimum.
